(19) United States
(12) Patent Application Publication
(10) Pub. No.: US 2019/0034464 A1
(43) Pub. Date: Jan. 31, 2019

(54) METHODS AND SYSTEMS THAT COLLECT DATA FROM COMPUTING FACILITIES AND EXPORT A SPECIFIED PORTION OF THE COLLECTED DATA FOR REMOTE PROCESSING AND ANALYSIS

(71) Applicant: VMware, Inc., Palo Alto, CA (US)

(72) Inventors: Marin Nozhchev, Palo Alto, CA (US); Velyo Chanin, Palo Alto, CA (US); Georgi Kostov, Sofia (BG)

(73) Assignee: VMware, Inc., Palo Alto, CA (US)

(21) Appl. No.: 15/665,211

(22) Filed: Jul. 31, 2017

(51) Int. Cl. G06F 17/30

(52) U.S. Cl. CPC G06F 17/30312; G06F 17/30477

(57) ABSTRACT

The current document is directed to methods and systems that collect data within computing facilities according to data-collection specifications contained in data-collection manifests and that export a specified portion of the collected data to remote data-processing and data-analysis systems based on data-export specifications encoded within data-export whitelists. In a disclosed implementation, collected data is hierarchically encoded within a file or document that is efficiently processed, using one or more regular expressions that comprise a data-export whitelist, to extract the specified portion of the collected data for export to a remote data-processing and data-analysis system.

### TECHNICAL FIELD

The current document is directed to collection of data within computing facilities and, in particular, to methods and systems that collect data within computing facilities on behalf of remote data-processing and data-analysis systems according to data-collection manifests and data-export whitelists.

### BACKGROUND

Early computer systems were generally large, single-processor systems that sequentially executed jobs encoded on huge decks of Hollerith cards. Over time, the parallel evolution of computer hardware and software produced main-frame computers and minicomputers with multi-tasking operation systems, increasingly capable personal computers, workstations, and servers, and, in the current environment, multi-processor mobile computing devices, personal computers, and servers interconnected through global networking and communications systems with one another and with massive virtual data centers and virtualized cloud-computing facilities. This rapid evolution of computer systems has been accompanied with greatly expanded needs for computer-system monitoring, management, and administration. Currently, these needs have begun to be addressed by highly capable automated monitoring, management, and administration tools and facilities. Many different types of automated monitoring, administration, and management facilities have emerged, providing many different products with overlapping functionalities, but each also providing unique functionalities and capabilities. Owners, managers, and users of large-scale computer systems continue to seek methods, systems, and technologies to provide secure, efficient, and cost-effective monitoring, management and administration of computing facilities, including cloud-computing facilities and other large-scale computer systems.

### SUMMARY

The current document is directed to methods and systems that collect data within computing facilities according to data-collection specifications contained in data-collection manifests and that export a specified portion of the collected data to remote data-processing and data-analysis systems based on data-export specifications encoded within data-export whitelists. In a disclosed implementation, collected data is hierarchically encoded within a file or document that is efficiently processed, using one or more regular expressions that comprise a data-export whitelist, to extract the specified portion of the collected data for export to a remote data-processing and data-analysis system.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 shows a representation of a common protocol stack.

FIG. 12 illustrates the role of resources in RESTful APIs.

FIGS. 13A-D illustrate four basic verbs, or operations, provided by the HTTP application-layer protocol used in RESTful applications.

FIGS. 14A-C illustrate a computational environment that provides a context for describing the currently disclosed methods and systems.

FIG. 15 illustrates various different classes of metric data.

FIG. 16 illustrates information exchanged between collectors and the phone-home subsystem to specify the subset D of metric data collected by a collector and the subset E of metric data exported by a collector to the phone-home subsystem.

FIGS. 17A-C provide control-flow diagrams that illustrate one implementation of the phone-home API.

FIGS. 18A-B illustrate XML-encoded data.

FIG. 19 illustrates the use of an XML stylesheet to extract a portion of the data contained in a first XML document for inclusion into a second, or result, XML document.

FIGS. 20A-D provide a simpler example of a data-containing XML document.

FIGS. 21A-B show graphical tree-like representations of the XML document shown in FIG. 20A.

FIGS. 22A-D provide examples of pathname-like regular expressions operating on the XML document provided in FIG. 20A.

FIGS. 23A-E provide data-structure diagrams and the control-flow diagrams that illustrate application of pathname-like regular expressions contained in a data-export whitelist to a data-containing XML document to select exportable data from the data-containing XML document for transmission to a phone-home subsystem from a collector resident within a computing facility.

### DETAILED DESCRIPTION

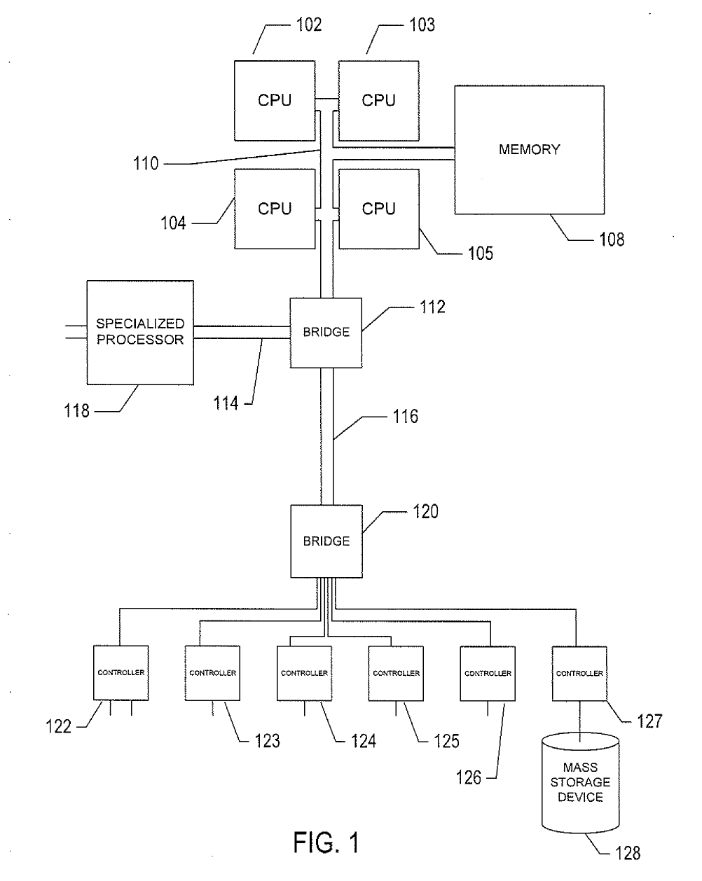

The current document is directed to methods and systems that collect performance data within computing facilities according to data-collection specifications contained in data-collection manifests and that export a portion of the collected data to remote data-processing and data-analysis systems based on data-export specifications encoded as regular expressions within data-export whitelists. In a first subsection, below, a detailed description of computer hardware, complex computational systems, virtualization, and RESTful protocols is provided with reference to FIGS. 1-13. In a second subsection, the currently disclosed methods and systems for collecting and exporting performance data are discussed.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

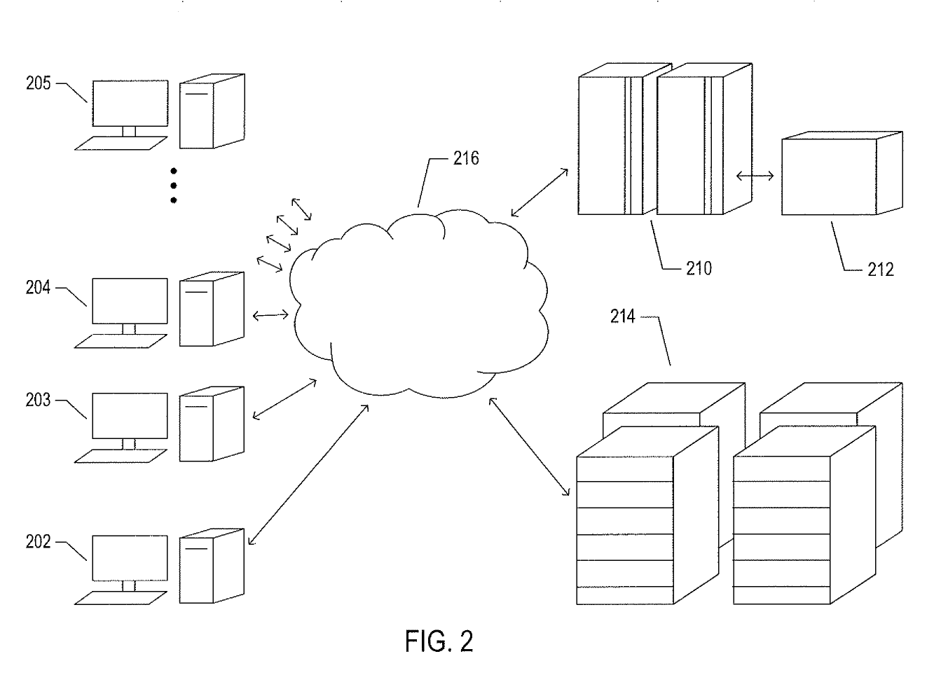

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

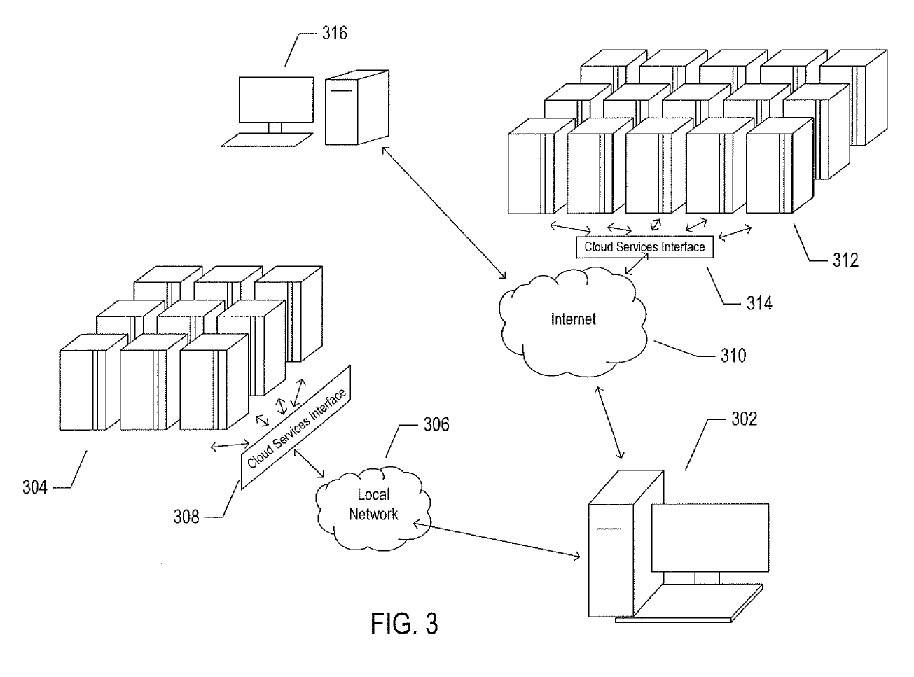

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

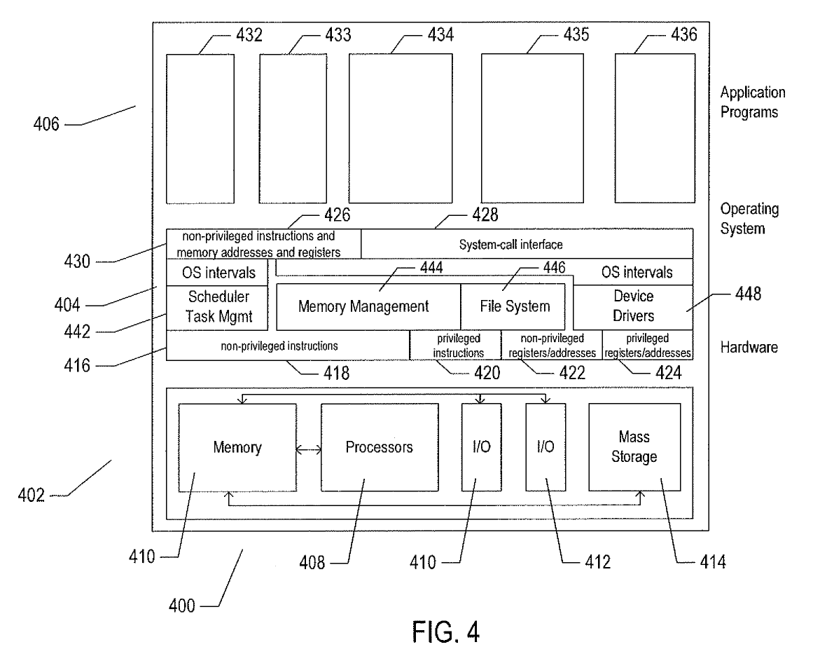

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

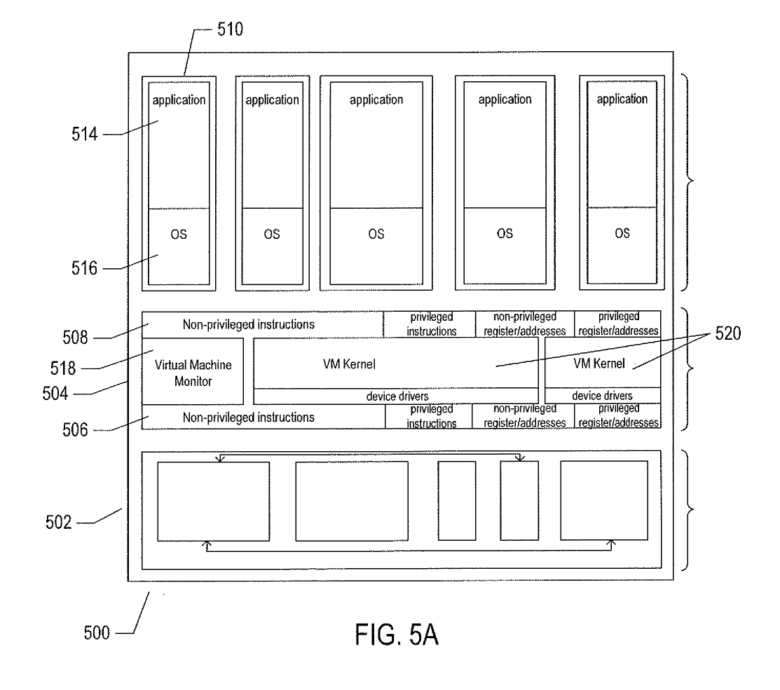

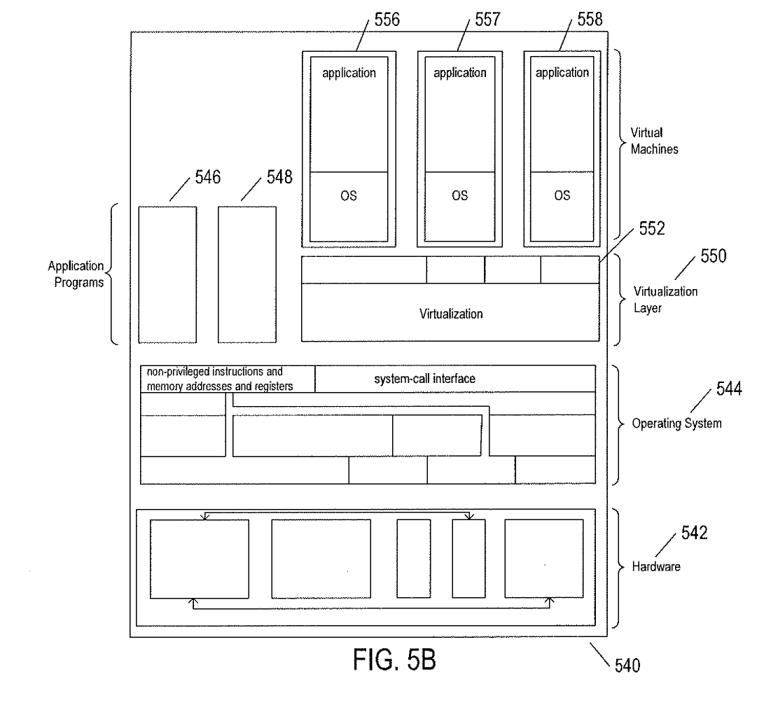

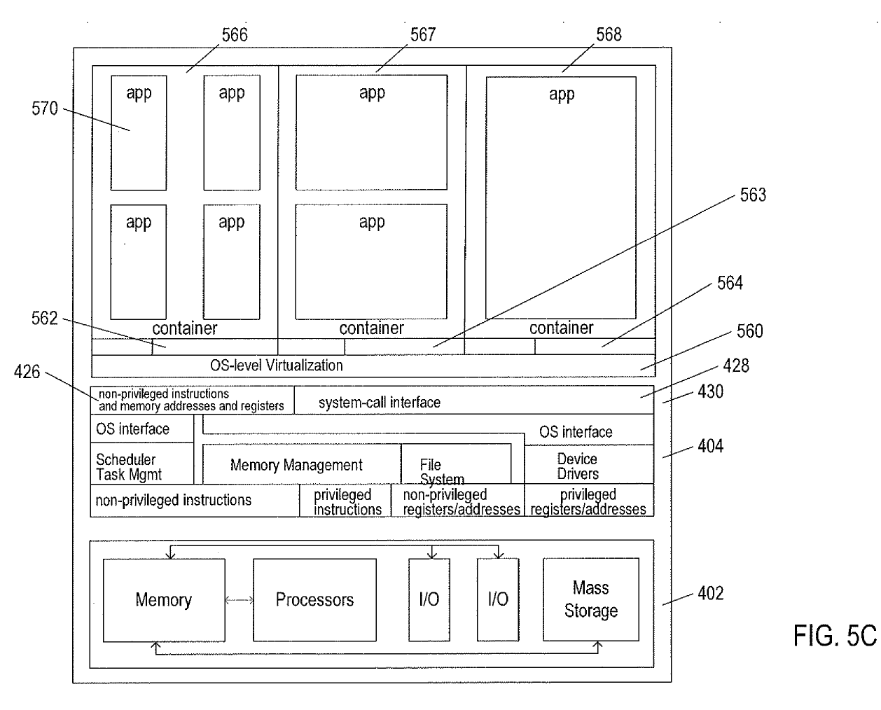

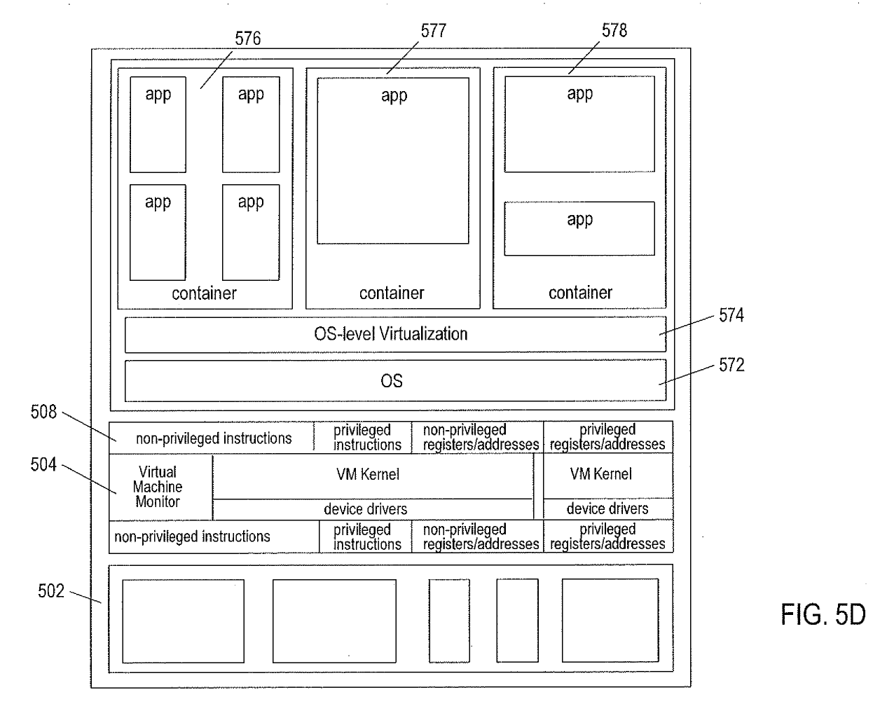

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications miming directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

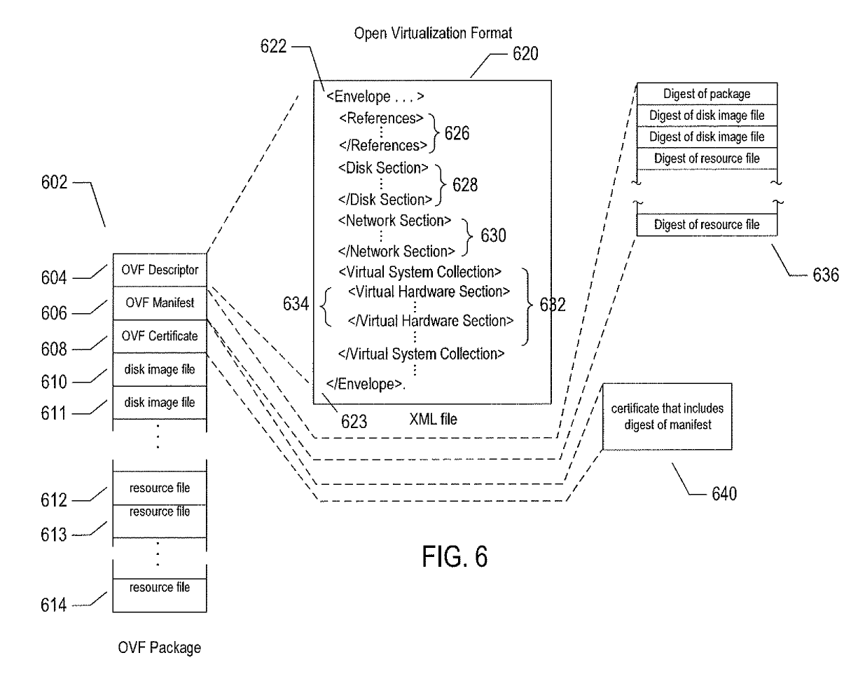

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

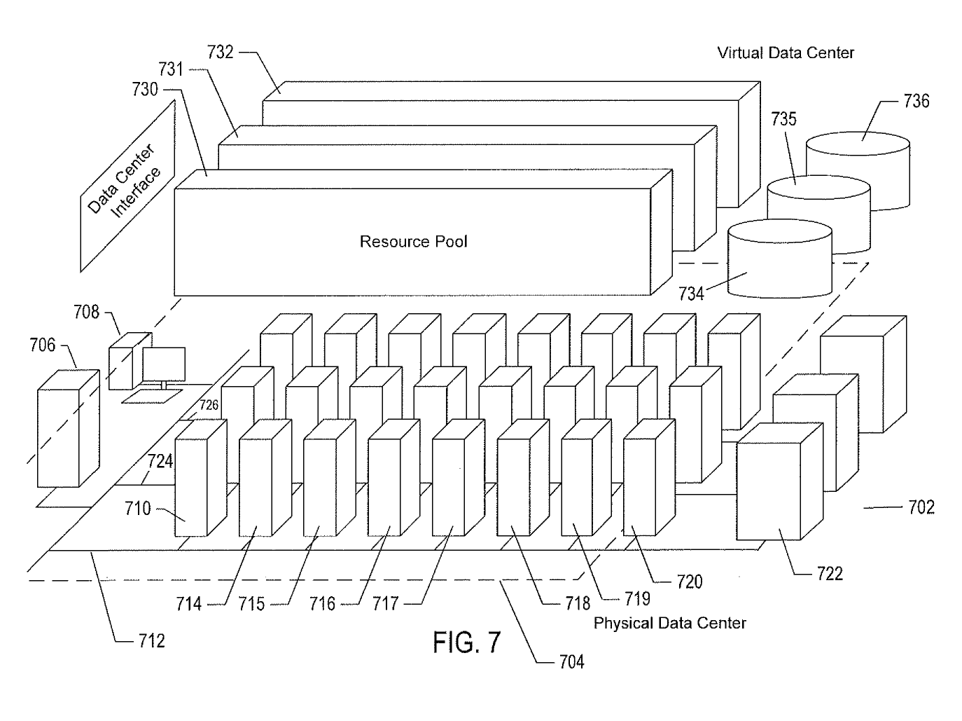

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

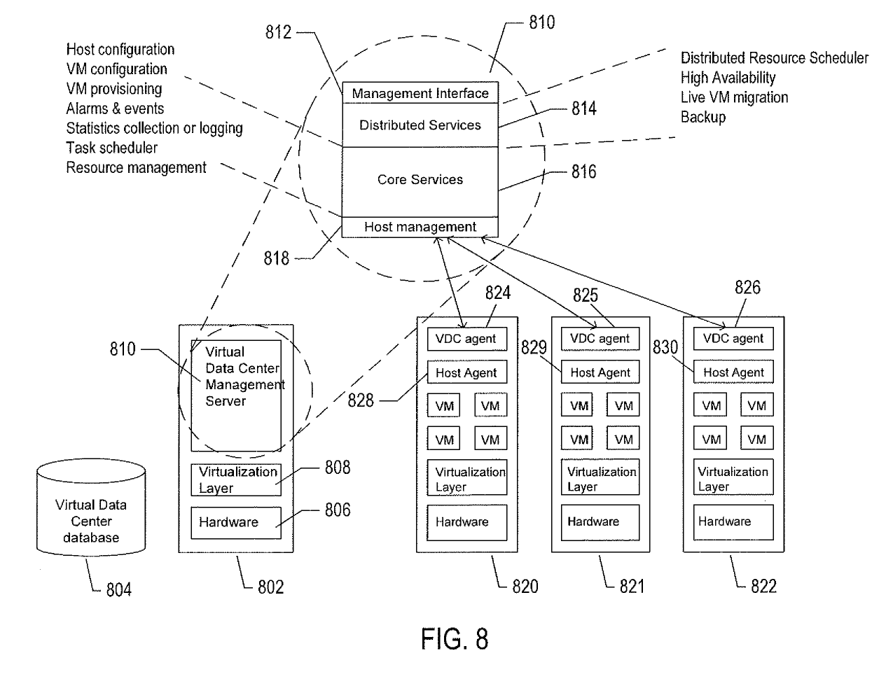

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808, and runs a virtual-data-center management-server virtual machine 810 above the virtualization layer. Although shown as a single server in FIG. 8, the VI-management-server (“VI management serve”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

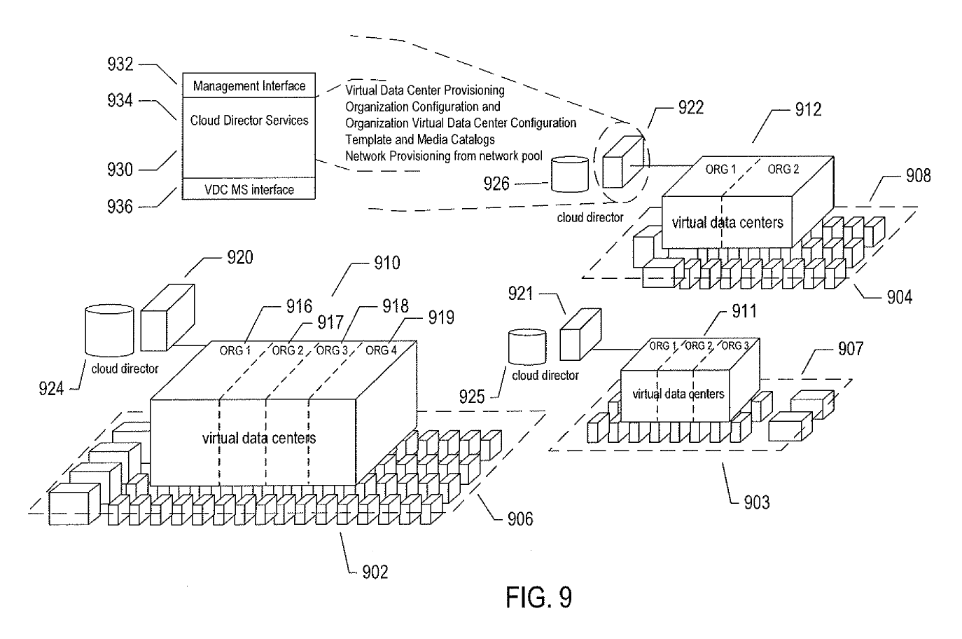

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

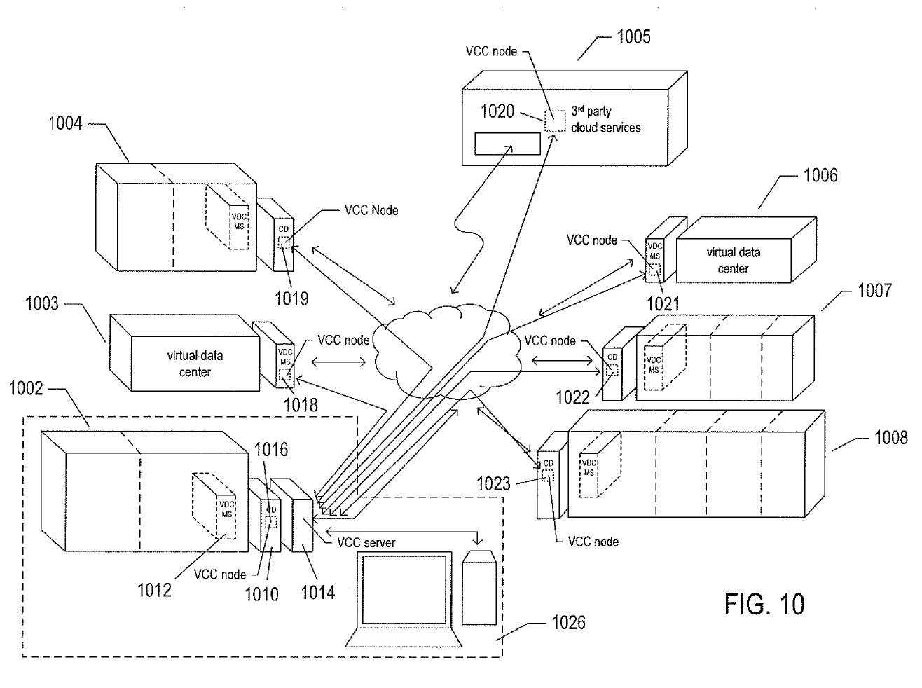

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

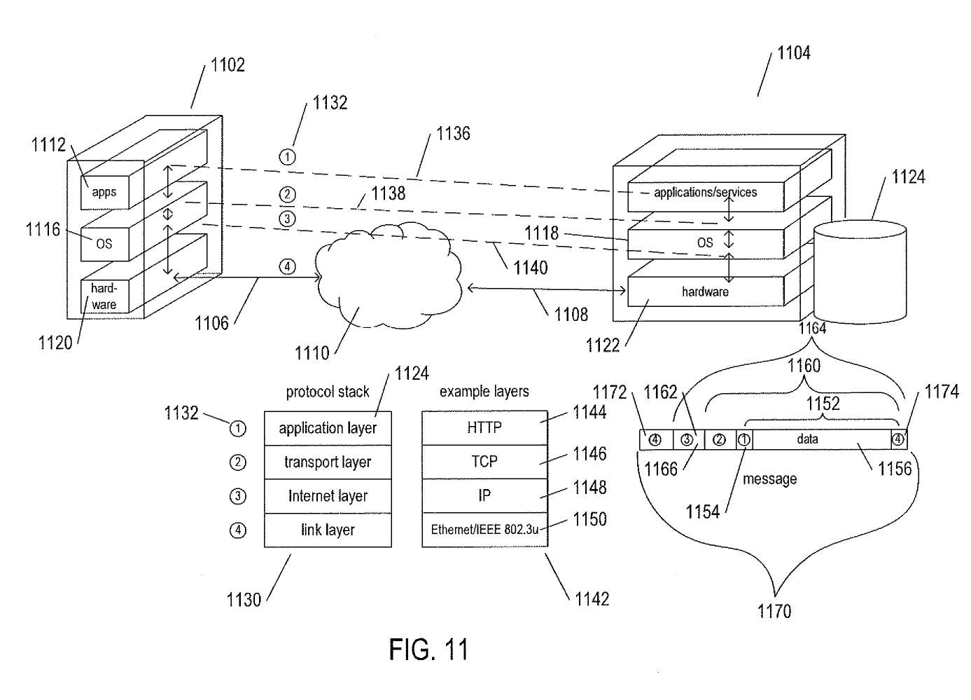

Electronic communications between computer systems generally comprises packets of information, referred to as datagrams, transferred from client computers to server computers and from server computers to client computers. In many cases, the communications between computer systems is commonly viewed from the relatively high level of an application program which uses an application-layer protocol for information transfer. However, the application-layer protocol is implemented on top of additional layers, including a transport layer, Internet layer, and link layer. These layers are commonly implemented at different levels within computer systems. Each layer is associated with a protocol for data transfer between corresponding layers of computer systems. These layers of protocols are commonly referred to as a “protocol stack.” FIG. 11 shows a representation of a common protocol stack. In FIG. 11, a representation of a common protocol stack 1130 is shown below the interconnected server and client computers 1104 and 1102. The layers are associated with layer numbers, such as layer number “1” 1132 associated with the application layer 1134. These same layer numbers are used in the depiction of the interconnection of the client computer 1102 with the server computer 1104, such as layer number “1” 1132 associated with a horizontal dashed line 1136 that represents interconnection of the application layer 1112 of the client computer with the applications/services layer 1114 of the server computer through an application-layer protocol. A dashed line 1136 represents interconnection via the application-layer protocol in FIG. 11, because this interconnection is logical, rather than physical. Dashed-line 1138 represents the logical interconnection of the operating-system layers of the client and server computers via a transport layer. Dashed line 1140 represents the logical interconnection of the operating systems of the two computer systems via an Internet-layer protocol. Finally, links 1106 and 1108 and cloud 1110 together represent the physical communications media and components that physically transfer data from the client computer to the server computer and from the server computer to the client computer. These physical communications components and media transfer data according to a link-layer protocol. In FIG. 11, a second table 1142 aligned with the table 1130 that illustrates the protocol stack includes example protocols that may be used for each of the different protocol layers. The hypertext transfer protocol (“HTTP”) may be used as the application-layer protocol 1144, the transmission control protocol (“TCP”) 1146 may be used as the transport-layer protocol, the Internet protocol 1148 (“IP”) may be used as the Internet-layer protocol, and, in the case of a computer system interconnected through a local Ethernet to the Internet, the Ethernet/IEEE 802.3u protocol 1150 may be used for transmitting and receiving information from the computer system to the complex communications components of the Internet. Within cloud 1110, which represents the Internet, many additional types of protocols may be used for transferring the data between the client computer and server computer.

Consider the sending of a message, via the HTTP protocol, from the client computer to the server computer. An application program generally makes a system call to the operating system and includes, in the system call, an indication of the recipient to whom the data is to be sent as well as a reference to a buffer that contains the data. The data and other information are packaged together into one or more HTTP datagrams, such as datagram 1152. The datagram may generally include a header 1154 as well as the data 1156, encoded as a sequence of bytes within a block of memory. The header 1154 is generally a record composed of multiple byte-encoded fields. The call by the application program to an application-layer system call is represented in FIG. 11 by solid vertical arrow 1158. The operating system employs a transport-layer protocol, such as TCP, to transfer one or more application-layer datagrams that together represent an application-layer message. In general, when the application-layer message exceeds some threshold number of bytes, the message is sent as two or more transport-layer messages. Each of the transport-layer messages 1160 includes a transport-layer-message header 1162 and an application-layer datagram 1152. The transport-layer header includes, among other things, sequence numbers that allow a series of application-layer datagrams to be reassembled into a single application-layer message. The transport-layer protocol is responsible for end-to-end message transfer independent of the underlying network and other communications subsystems, and is additionally concerned with error control, segmentation, as discussed above, flow control, congestion control, application addressing, and other aspects of reliable end-to-end message transfer. The transport-layer datagrams are then forwarded to the Internet layer via system calls within the operating system and are embedded within Internet-layer datagrams 1164, each including an Internet-layer header 1166 and a transport-layer datagram. The Internet layer of the protocol stack is concerned with sending datagrams across the potentially many different communications media and subsystems that together comprise the Internet. This involves routing of messages through the complex communications systems to the intended destination. The Internet layer is concerned with assigning unique addresses, known as “IP addresses,” to both the sending computer and the destination computer for a message and routing the message through the Internet to the destination computer. Internet-layer datagrams are finally transferred, by the operating system, to communications hardware, such as a network-interface controller (“NIC”) which embeds the Internet-layer datagram 1164 into a link-layer datagram 1170 that includes a link-layer header 1172 and generally includes a number of additional bytes 1174 appended to the end of the Internet-layer datagram. The link-layer header includes collision-control and error-control information as well as local-network addresses. The link-layer packet or datagram 1170 is a sequence of bytes that includes information introduced by each of the layers of the protocol stack as well as the actual data that is transferred from the source computer to the destination computer according to the application-layer protocol.

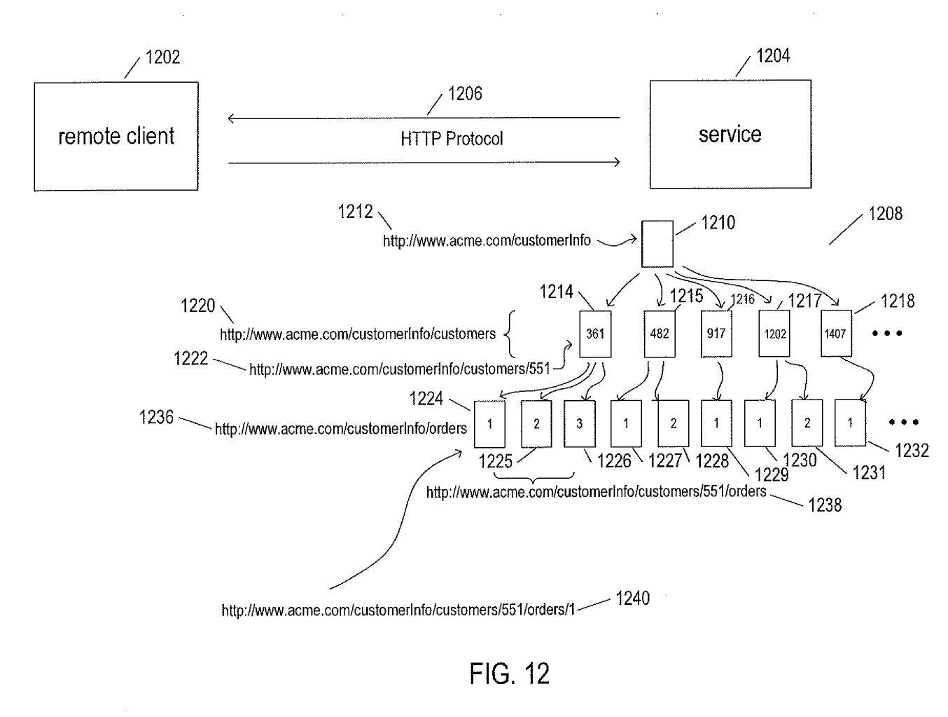

Next, the RESTful approach to web-service APIs is described, beginning with FIG. 12. FIG. 12 illustrates the role of resources in RESTful APIs. In FIG. 12, and in subsequent figures, a remote client 1202 is shown to be interconnected and communicating with a service provided by one or more service computers 1204 via the HTTP protocol 1206. Many RESTful APIs are based on the HTTP protocol. Thus, the focus is on the application layer in the following discussion. However, as discussed above with reference to FIG. 12, the remote client 1202 and service provided by one or more server computers 1204 are, in fact, physical systems with application, operating-system, and hardware layers that are interconnected with various types of communications media and communications subsystems, with the HTTP protocol the highest-level layer in a protocol stack implemented in the application, operating-system, and hardware layers of client computers and server computers. The service may be provided by one or more server computers, as discussed above in a preceding section. As one example, a number of servers may be hierarchically organized as various levels of intermediary servers and end-point servers. However, the entire collection of servers that together provide a service are addressed by a domain name included in a uniform resource identifier (“URI”), as further discussed below. A RESTful API is based on a small set of verbs, or operations, provided by the HTTP protocol and on resources, each uniquely identified by a corresponding URI. Resources are logical entities, information about which is stored on one or more servers that together comprise a domain. URIs are the unique names for resources. A resource about which information is stored on a server that is connected to the Internet has a unique URI that allows that information to be accessed by any client computer also connected to the Internet with proper authorization and privileges. URIs are thus globally unique identifiers, and can be used to specify resources on server computers throughout the world. A resource may be any logical entity, including people, digitally encoded documents, organizations, and other such entities that can be described and characterized by digitally encoded information. A resource is thus a logical entity. Digitally encoded information that describes the resource and that can be accessed by a client computer from a server computer is referred to as a “representation” of the corresponding resource. As one example, when a resource is a web page, the representation of the resource may be a hypertext markup language (“HTML”) encoding of the resource. As another example, when the resource is an employee of a company, the representation of the resource may be one or more records, each containing one or more fields, that store information characterizing the employee, such as the employee's name, address, phone number, job title, employment history, and other such information.

In the example shown in FIG. 12, the web servers 1204 provides a RESTful API based on the HTTP protocol 1206 and a hierarchically organized set of resources 1208 that allow clients of the service to access information about the customers and orders placed by customers of the Acme Company. This service may be provided by the Acme Company itself or by a third-party information provider. All of the customer and order information is collectively represented by a customer information resource 1210 associated with the URI “http://www.acme.com/customerInfo” 1212. As discussed further, below, this single URI and the HTTP protocol together provide sufficient information for a remote client computer to access any of the particular types of customer and order information stored and distributed by the service 1204. A customer information resource 1210, referred to as an “endpoint,” represents a large number of subordinate resources. These subordinate resources include, for each of the customers of the Acme Company, a customer resource, such as customer resource 1214. All of the customer resources 1214-1218 are collectively named or specified by the single URI “http://www.acme.com/customerInfo/customers” 1220. Individual customer resources, such as customer resource 1214, are associated with customer-identifier numbers and are each separately addressable by customer-resource-specific URIs, such as URI “http://www.acme.com/customerInfo/customers/361” 1222 which includes the customer identifier “361” for the customer represented by customer resource 1214. Each customer may be logically associated with one or more orders. For example, the customer represented by customer resource 1214 is associated with three different orders 1224-1226, each represented by an order resource. All of the orders are collectively specified or named by a single URI “http://www.acme.com/customerInfo/orders” 1236. All of the orders associated with the customer represented by resource 1214, orders represented by order resources 1224-1226, can be collectively specified by the URI “http://www.acme.com/customerInfo/customers/361/orders” 1238. A particular order, such as the order represented by order resource 1224, may be specified by a unique URI associated with that order, such as URI “http://www.acme.com/customerInfo/customers/361/orders/1” 1240, where the final “1” is an order number that specifies a particular order within the set of orders corresponding to the particular customer identified by the customer identifier “361.”

In one sense, the URIs bear similarity to pathnames to files in file directories provided by computer operating systems. However, it should be appreciated that resources, unlike files, are logical entities rather than physical entities, such as the set of stored bytes that together compose a file within a computer system. When a file is accessed through a pathname, a copy of a sequence of bytes that are stored in a memory or mass-storage device as a portion of that file are transferred to an accessing entity. By contrast, when a resource is accessed through a URI, a server computer returns a digitally encoded representation of the resource, rather than a copy of the resource. For example, when the resource is a human being, the service accessed via a URI specifying the human being may return alphanumeric encodings of various characteristics of the human being, a digitally encoded photograph or photographs, and other such information. Unlike the case of a file accessed through a pathname, the representation of a resource is not a copy of the resource, but is instead some type of digitally encoded information with respect to the resource.

In the example RESTful API illustrated in FIG. 12, a client computer can use the verbs, or operations, of the HTTP protocol and the top-level URI 1212 to navigate the entire hierarchy of resources 1208 in order to obtain information about particular customers and about the orders that have been placed by particular customers.

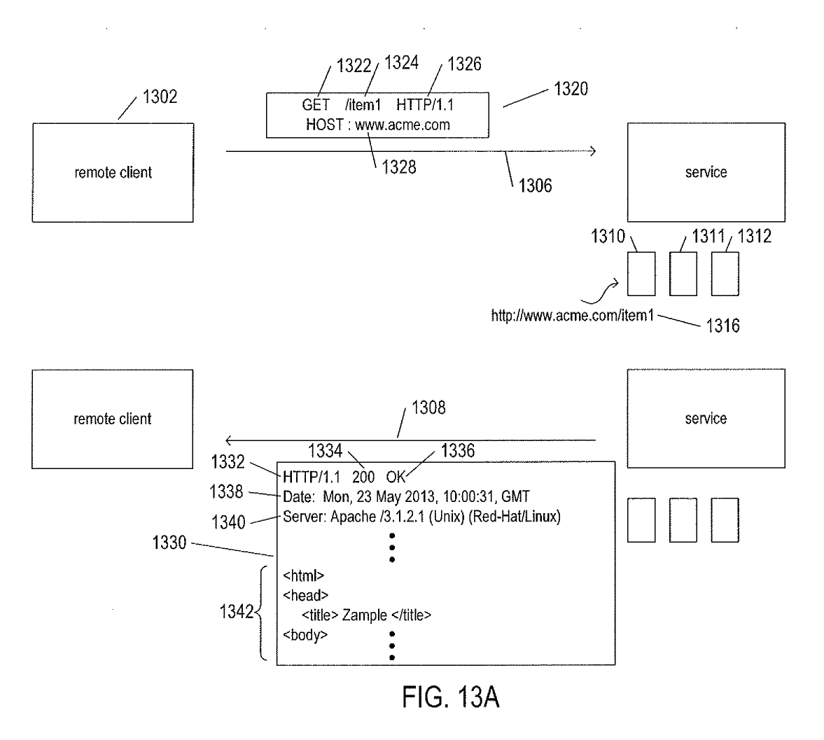

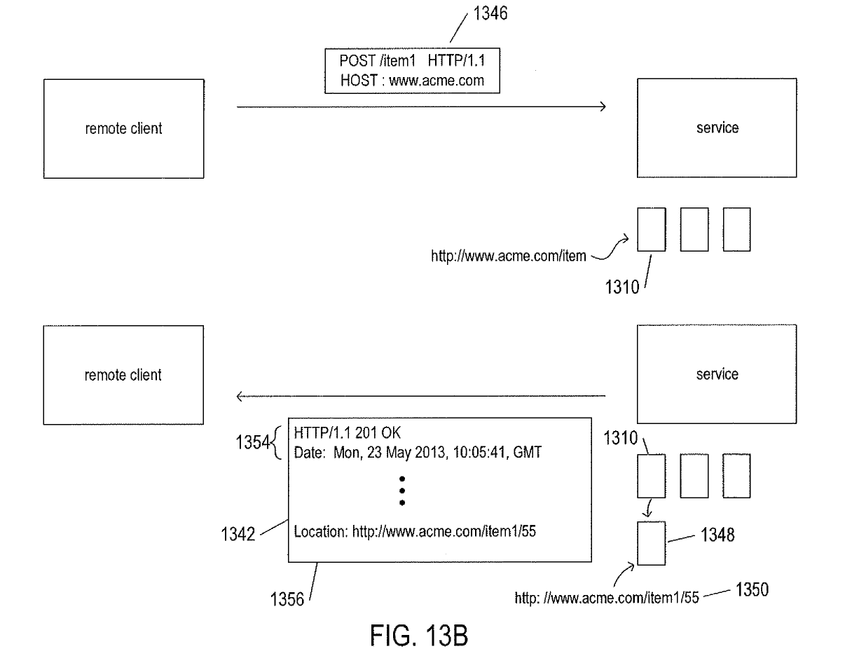

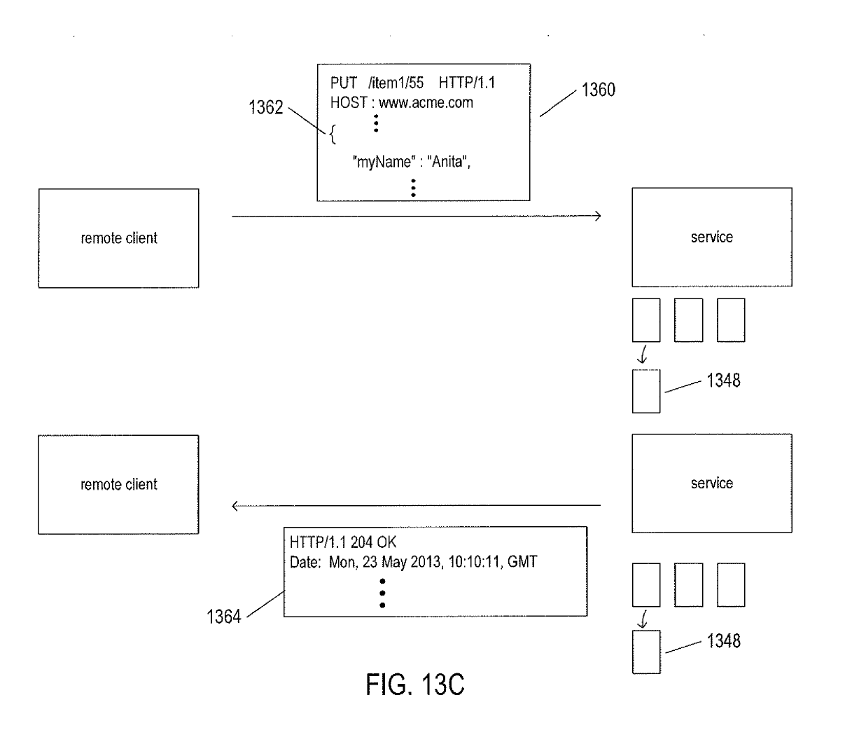

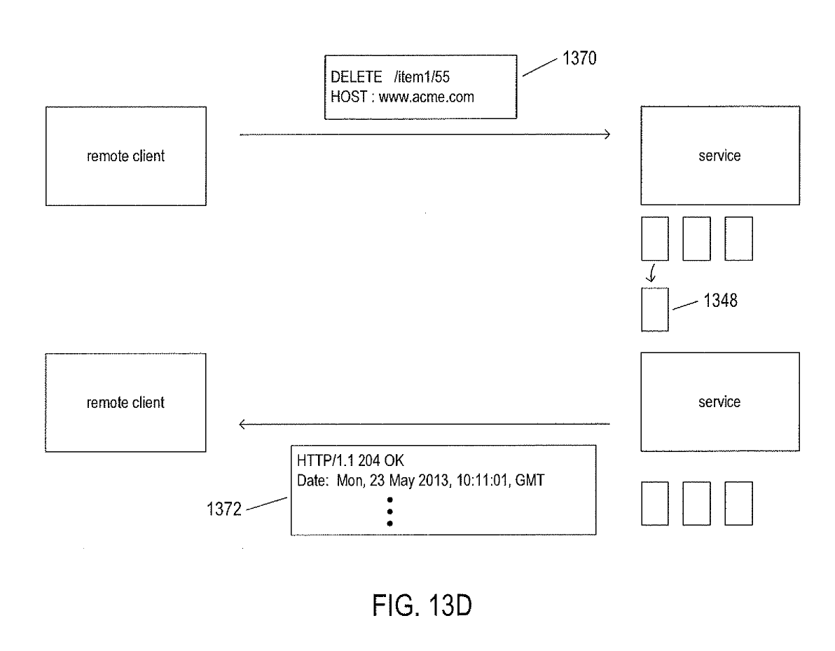

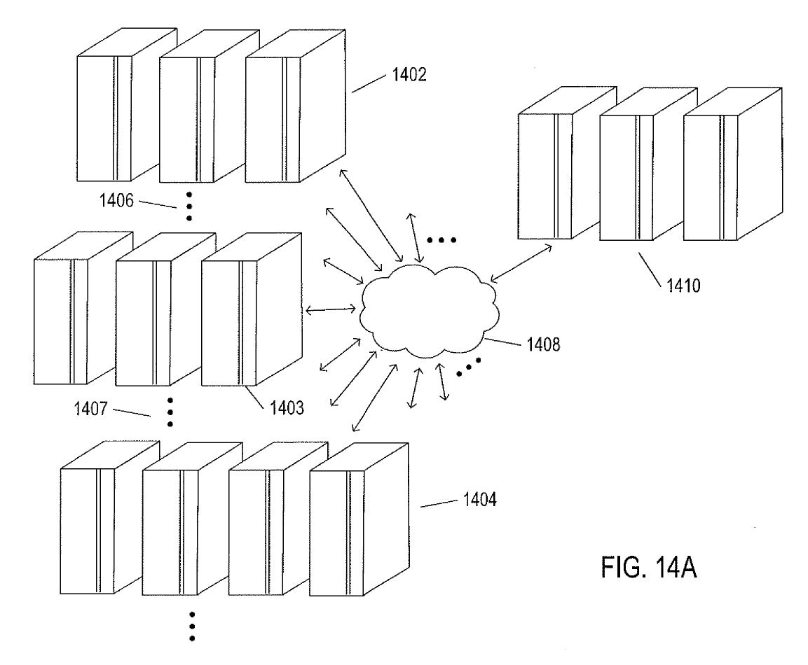

FIGS. 13A-D illustrate four basic verbs, or operations, provided by the HTTP application-layer protocol used in RESTful applications. RESTful applications are client/server protocols in which a client issues an HTTP request message to a service or server and the service or server responds by returning a corresponding HTTP response message. FIGS. 13A-D use the illustration conventions discussed above with reference to FIG. 12 with regard to the client, service, and HTTP protocol. For simplicity and clarity of illustration, in each of these figures, a top portion illustrates the request and a lower portion illustrates the response. The remote client 1302 and service 1304 are shown as labeled rectangles, as in FIG. 12. A right-pointing solid arrow 1306 represents sending of an HTTP request message from a remote client to the service and a left-pointing solid arrow 1308 represents sending of a response message corresponding to the request message by the service to the remote client. For clarity and simplicity of illustration, the service 1304 is shown associated with a few resources 1310-1312.

FIG. 13A illustrates the GET request and a typical response. The GET request requests the representation of a resource identified by a URI from a service. In the example shown in FIG. 13A, the resource 1310 is uniquely identified by the URI “http://www.acme.com/item1” 1316. The initial substring “http://www.acme.com” is a domain name that identifies the service. Thus, URI 1316 can be thought of as specifying the resource “item1” that is located within and managed by the domain “www.acme.com.” The GET request 1320 includes the command “GET” 1322, a relative resource identifier 1324 that, when appended to the domain name, generates the URI that uniquely identifies the resource, and in an indication of the particular underlying application-layer protocol 1326. A request message may include one or more headers, or key/value pairs, such as the host header 1328 “host:www.acme.com” that indicates the domain to which the request is directed. There are many different headers that may be included. In addition, a request message may also include a request-message body. The body may be encoded in any of various different self-describing encoding languages, often JSON, XML, or HTML. In the current example, there is no request-message body. The service receives the request message containing the GET command, processes the message, and returns a corresponding response message 1330. The response message includes an indication of the application-layer protocol 1332, a numeric status 1334, a textural status 1336, various headers 1338 and 1340, and, in the current example, a body 1342 that includes the HTML encoding of a web page. Again, however, the body may contain any of many different types of information, such as a JSON object that encodes a personnel file, customer description, or order description. GET is the most fundamental and generally most often used verb, or function, of the HTTP protocol.

FIG. 13B illustrates the POST HTTP verb. In FIG. 13B, the client sends a POST request 1346 to the service that is associated with the URI “http://www.acme.com/item1.” In many RESTful APIs, a POST request message requests that the service create a new resource subordinate to the URI associated with the POST request and provide a name and corresponding URI for the newly created resource. Thus, as shown in FIG. 13B, the service creates a new resource 1348 subordinate to resource 1310 specified by URI “http://www.acme.com/item1,” and assigns an identifier “36” to this new resource, creating for the new resource the unique URI “http://www.acme.com/item1/36” 1350. The service then transmits a response message 1352 corresponding to the POST request back to the remote client. In addition to the application-layer protocol, status, and headers 1354, the response message includes a location header 1356 with the URI of the newly created resource. According to the HTTP protocol, the POST verb may also be used to update existing resources by including a body with update information. However, RESTful APIs generally use POST for creation of new resources when the names for the new resources are determined by the service. The POST request 1346 may include a body containing a representation or partial representation of the resource that may be incorporated into stored information for the resource by the service.

FIG. 13C illustrates the PUT HTTP verb. In RESTful APIs, the PUT HTTP verb is generally used for updating existing resources or for creating new resources when the name for the new resources is determined by the client, rather than the service. In the example shown in FIG. 13C, the remote client issues a PUT HTTP request 1360 with respect to the URI “http://www.acme.com/item1/36” that names the newly created resource 1348. The PUT request message includes a body with a JSON encoding of a representation or partial representation of the resource 1362. In response to receiving this request, the service updates resource 1348 to include the information 1362 transmitted in the PUT request and then returns a response corresponding to the PUT request 1364 to the remote client.

FIG. 13D illustrates the DELETE HTTP verb. In the example shown in FIG. 13D, the remote client transmits a DELETE HTTP request 1370 with respect to URI “http://www.acme.com/item1/36” that uniquely specifies newly created resource 1348 to the service. In response, the service deletes the resource associated with the URL and returns a response message 1372.

### Methods and Systems that Collect and Export Data from Computing Facilities

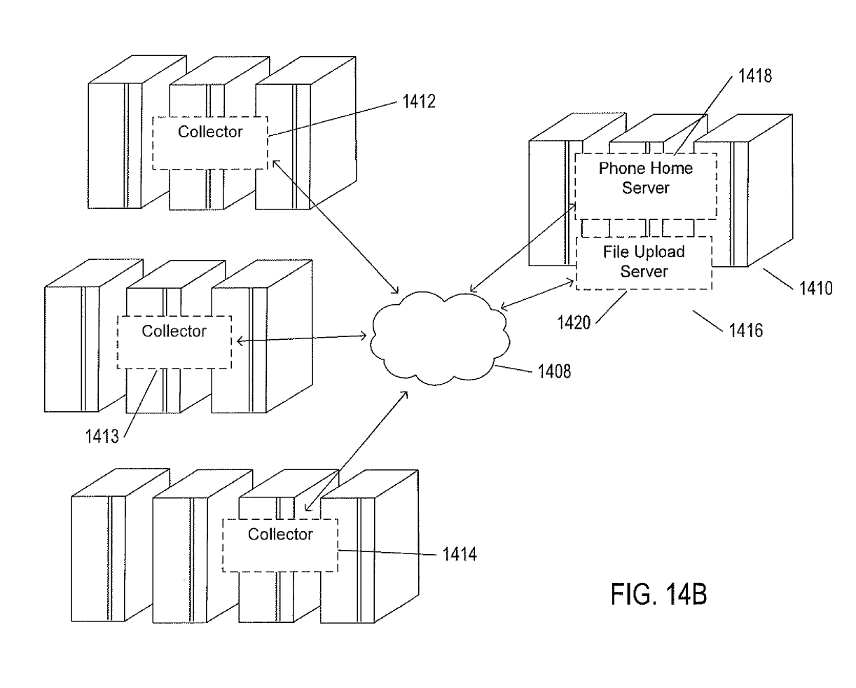

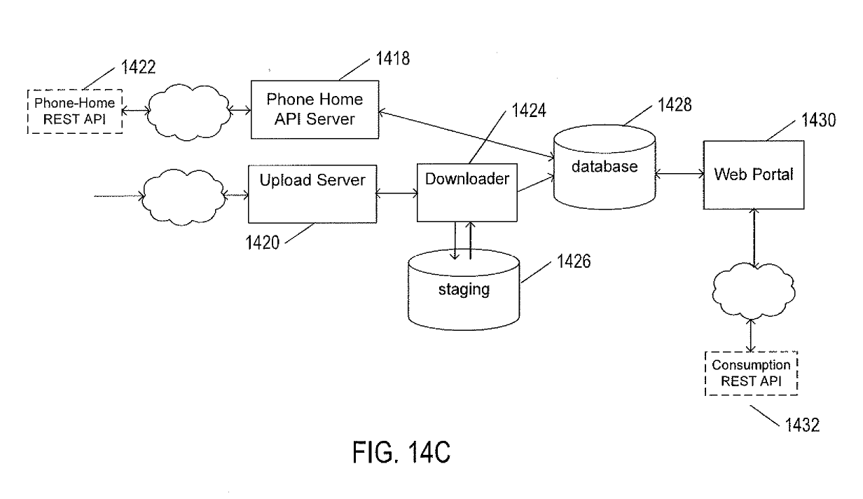

FIGS. 14A-C illustrate a computational environment that provides a context for describing the currently disclosed methods and systems. As shown in FIG. 14A, many different computing facilities, including computing facilities 1402-1404 shown in FIG. 14A and many additional computing facilities indicated by ellipses 1406-1407, are interconnected by various electronic communications systems, represented by cloud 1408, with a data-processing and data-analysis system 1410. Data is collected within the computing facilities 1402-1404 and forwarded to the data-processing and data-analysis system 1410 for process, analysis, and other uses. As one example used in the following discussion, the data-processing and data-analysis system 1410 may be a computing facility managed by a systems software vendor and the computing facilities 1402-1404 belong to customers of the systems software vendor and include system software developed and sold by the system software vendor. Metric data that characterizes the performance and operational characteristics of the systems software installed within the computing facilities 1402-1404 is collected within each computing facility by a collector incorporated within the systems software or installed within the computing facilities by or on behalf of the system software vendor. The data-processing and data-analysis system uses the collected metric data to analyze performance and operational behaviors of the systems software incorporated into the computing facilities, detect problems and issues that arise during execution of the system software on the computing facilities, and to compile information that can be used to tune, reconfigure, and modify instances of the system software in computing facilities and to develop improved versions of the system software.

FIG. 14B illustrates components of a distributed data-collection system that is used to collect data and export data from the computing facilities to the data-processing and data-analysis system in the example environment shown in FIG. 14A. Each of the computing facilities includes a collector 1412-1414. The collectors continuously collect and store metric data within the computing facilities. At intervals defined by various criteria, including the amount of data already collected and stored in buffers and the elapsed time since collected data was last aggregated into a data file or data document, the collectors encode collected data into a document or file and export the data through electronic communications systems 1408 to a phone-home data-collection and data-aggregation subsystem 1416 within the data-processing and data-analysis system 1410. The phone-home subsystem 1416 includes a phone-home application programming interface (“API”) server 1418 and a file-upload server 1420. The phone-home server 1418 provides a phone-home interface to the collectors 1412-1414. In one implementation, the phone-home API server provides the phone-home interface via a REST protocol, discussed in the preceding subsection. The phone-home API provides collectors, upon request, with data-collection manifests and data-export whitelists and provides an interface by which collectors can schedule data uploads to the phone-home subsystem. The file-upload server 1420 provides metric-data-upload services to the collectors.

FIG. 14C provides a block diagram of the components of one implementation of the phone-home subsystem. The phone-home API server 1418 exposes the public phone-home API 1422 that allows remote collectors to obtain manifests, data-export whitelists, and to schedule data uploads to the phone-home subsystem. The upload server 1420 receives data from collectors. The downloader 1424 monitors the upload server for arrival of new data. When new data is available on the upload server, the downloader downloads the data to a staging area 1426 and removes the data from the upload server. In addition, the downloader stores an index to the downloaded data in a database 1428 to facilitate access to the downloaded data by data-processing and data-analysis functionalities within the data-processing and data-analysis system. Data is maintained within the staging area for a specified period of time, after which the data is either deleted or archived, depending on the implementation. The database 1428 maintains indexes for downloaded data as well as information about collectors and other information used to configure and control operation of the phone-home subsystem. A web portal 1430 provides an internal web portal to functionalities within the data-analysis and data-processing system that are accessed through a consumption REST API 1432.

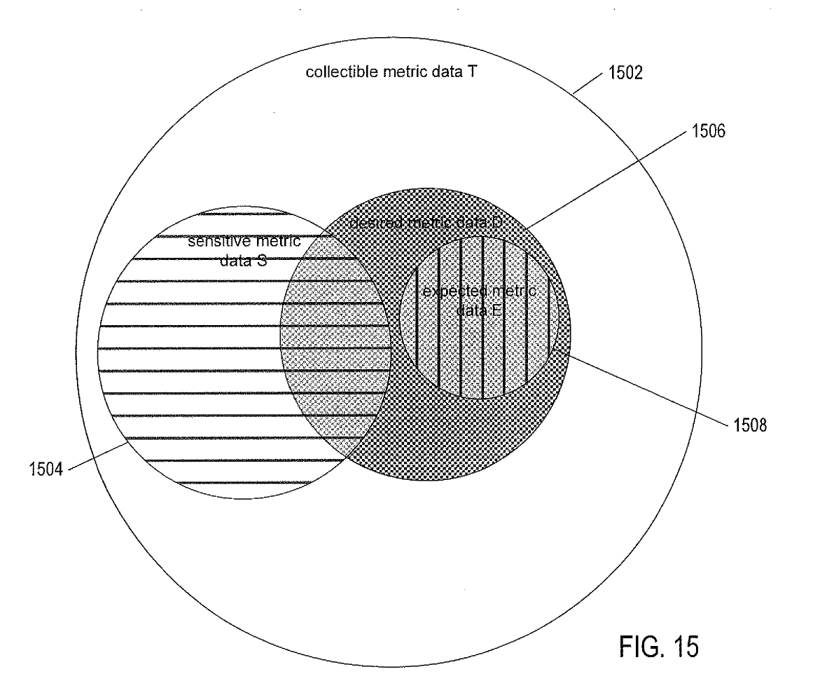

FIG. 15 illustrates various different classes of metric data. The phrase “metric data” refers to performance data, operational-characteristics data, application-usage data, and other such data collected by collectors within remote computing facilities on behalf of the phone-home service. FIG. 15 uses a Venn-diagram approach for illustrating four different classes of metric data. The largest set of metric data 1502 is a set T that includes all the different types of metric data that may possibly be collected by collectors within remote computing facilities. This metric data may be harvested from virtualization-layer and operating-system event messages, in real time or from event-message log files, but may also be actively collected by monitoring functionalities at the operating-system, virtualization-layer levels as well as by application-level software. The metric data may range from very particular types of processor events, such as the number of page faults and transaction-lookaside-buffer misses, to particular characteristics of communications subsystems, such as the number of packet-transmission retries and the amount of data transmitted during a fixed interval of time, to high-level data related to monitored vendor software, such as the number of virtual machines configured and launched over a specified time interval. Of course, the set T is dependent on the types of computer systems and computer-system components in a computational facility, the types of virtualization layers and operating systems running within those computer systems, and on the types of applications and other high-level entities running within the computational facility. A subset S of the total collectible metric data 1504 includes any of the collectible metric data that may be deemed, by the owners, managers, administrators, or other individuals associated with a computing facility within which a collector runs, to be sensitive and therefore unavailable for export from the computing facility to the phone-home subsystem. Another subset D 1506 of the set of collectable data T is the metric data that is specified, by the phone-home subsystem, for collection by collectors. This set is generally determined by the phone-home subsystem based on configuration parameters, administrative input, and on the specific needs of the various data-processing and data-analysis entities that access the data through the consumption REST API. Yet another subset E of metric data 1508 is the metric data that is specified, by the phone-home subsystem, for export from a computational facility to the phone-home subsystem. As indicated in FIG. 15, the metric data specified for export 1508 is a subset of the metric data specified for collection D 1506 and does not overlap, or include, any sensitive metric data S 1504.

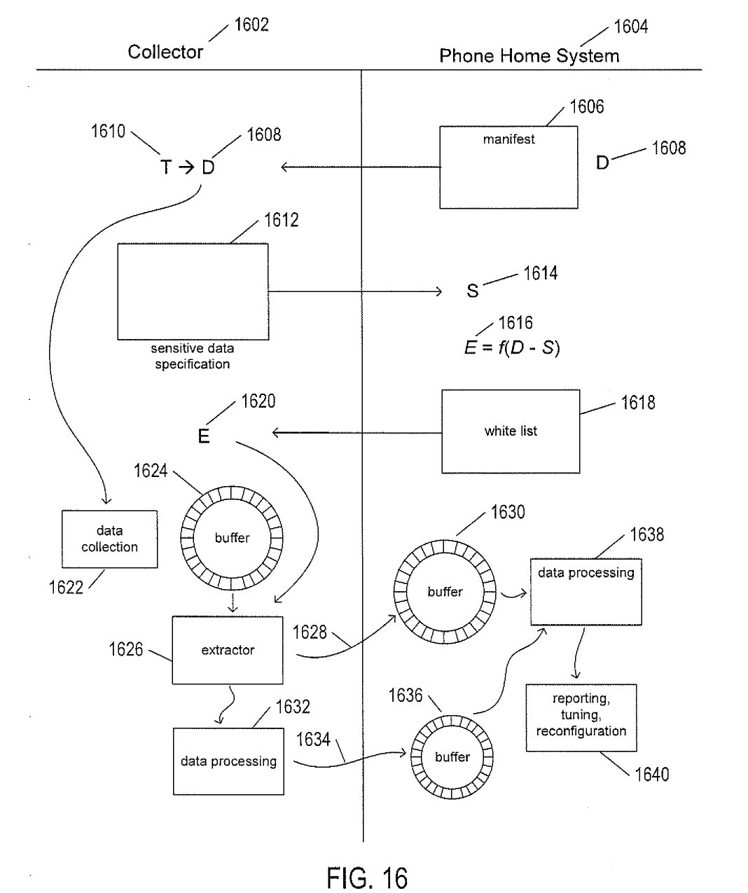

FIG. 16 illustrates information exchanged between collectors and the phone-home subsystem to specify the subset D of metric data collected by a collector and the subset E of metric data exported by a collector to the phone-home subsystem. FIG. 16 is divided into two vertical portions 1602 and 1604. The left-hand portion 1602 represents a collector and the right-hand portion 1604 represents the phone-home subsystem. A specification of the subset D of metric data to be collected by a collector is contained within a data-collection manifest 1606. Various different types of encodings may be used for specification of the metric data for collection. In certain implementations, the information may be encoded in the extensible markup language (“XML”) within an XML document. In other implementations, the information may be encoded in JavaScript Object Notation (“JSON”). Many other types of data-encapsulation methods may be used in additional implementations. As discussed further, below, the data-collection manifest is requested through the phone-home API by a collector in preparation for collecting a next dataset. Thus, as shown in FIG. 16, the data-collection manifest 1606, which specifies subset D 1608, is returned by the phone-home API server to the collector, which allows the collector to select, for collection, the metric data of subsets D 1608 from the total set of collectible metric data T 1610. By contrast, a specification 1612 of the sensitive metric data of subset S is generally transmitted from the collector to the phone-home subsystem to make the phone-home subsystem aware of subset S 1614. The mechanism for communication of a specification for subset S to the phone-home subsystem varies with different implementations. In certain implementations, the specification of the subset S is made through an interface other than the phone-home-system API. In certain implementations, determination of the subset S may involve a cooperative process to which both the collector and the phone-home subsystem contribute. In certain implementations, the phone-home-system API may include an entrypoint to permit updates to, and tailoring of, the specification of the metric-data subset S by collectors.

The phone-home subsystem determines the subset E 1616 of metric data to be exported by a collector to the phone-home subsystem using subsets D and S for a particular collector and the remote computing facility in which the collector executes. In general, the metric data to be exported from the remote computing facility by the collector to the phone-home subsystem is a proper subset of the difference metric-data subset D-S. This is because, in many cases, specification of certain data within the set of data to be collected, D, as being sensitive renders additional related data within the subset D unusable to the data-processing and data-analysis system, even were the related data exported to the phone-home subsystem. Having determined the metric-data subset E, the phone-home subsystem prepares a data-export whitelist 1618 that encodes the specification of the metric-data to be exported as a set of regular expressions and transmits the data-export whitelist to the collector, providing the collector with a definition of the subset E 1620. Thus, specification of the metric-data subset E involves transmission of a data-collection manifest 1606 and a data-export whitelist 1618 from the phone-home subsystem to the collector as well as transfer of a specification of the metric-data subset S 1612 from the collector, or from a system administrator or other individual who manages the remote computing facility in which the collector executes, to the phone-home subsystem.

FIG. 16 additionally illustrates how data is collected and exported by the collector using a block representation of data-collection, data-processing, and export functionalities as well as data structures. The data collector 1622 is configured to collect data of metric-data subset D 1608 from the computing facility in which the data collector executes. This data is input to a data-collection buffer 1624. In certain implementations, data collection occurs continuously and asynchronously with respect to other data-collector functionalities. An extractor component 1626 periodically extracts data from buffer 1624 and incorporates it into an encoded file, in one implementation an XML document. The extractor component processes the XML document to extract data belonging to metric-data subset E 1620 and copy the extracted data into memory for transmission to the phone-home subsystem 1628, where the data is stored in a phone-home-system buffer 1630, previously identified in FIG. 14C as the staging area 1426. The XML document may then be internally transferred to a data-processing component 1632 that runs within the computing facility to produce derived results that are not sensitive and that are therefore sent 1634 to a storage buffer within the phone-home subsystem 1636. The phone-home subsystem can then forward both unprocessed collected data, from buffer 1630, and remotely computed results, from buffer 1636, to data-processing functionality 1638 within the data-processing and data-analysis system for various uses, including preparing reports, tuning remotely executing vendor software, reconfiguring vendor software on remote computing facilities, and other purposes 1640. In certain implementations, data processing within the remote computing facilities, represented by block 1632 in FIG. 16, may not be undertaken. The extractor may copy extracted data into a second XML document for transmission to the phone-home subsystem, in certain implementations, or may simply stream the extracted data to the upload server, in other implementations.

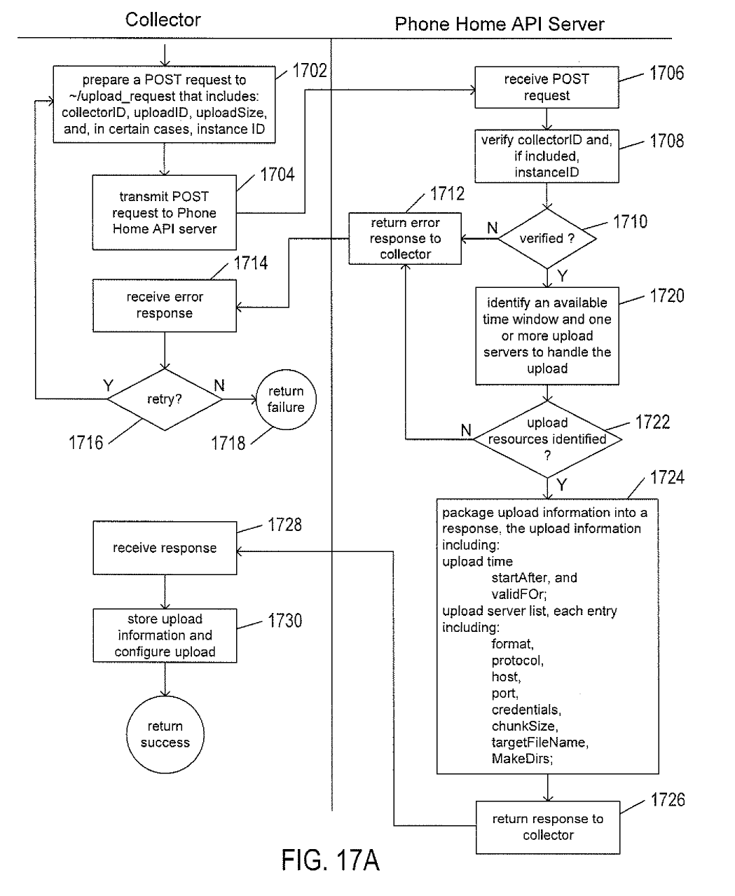

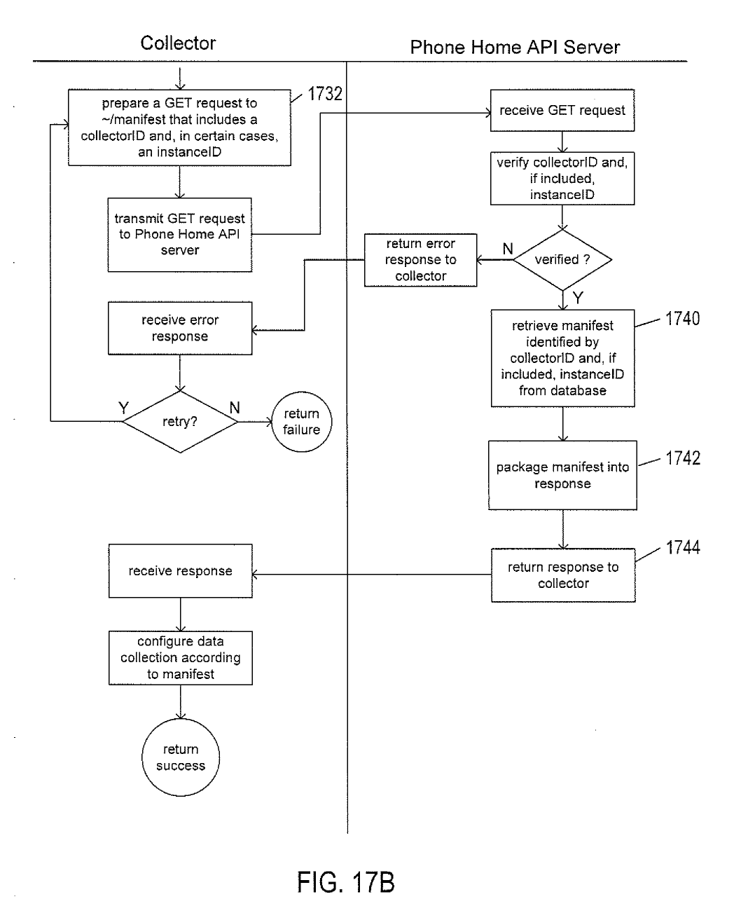

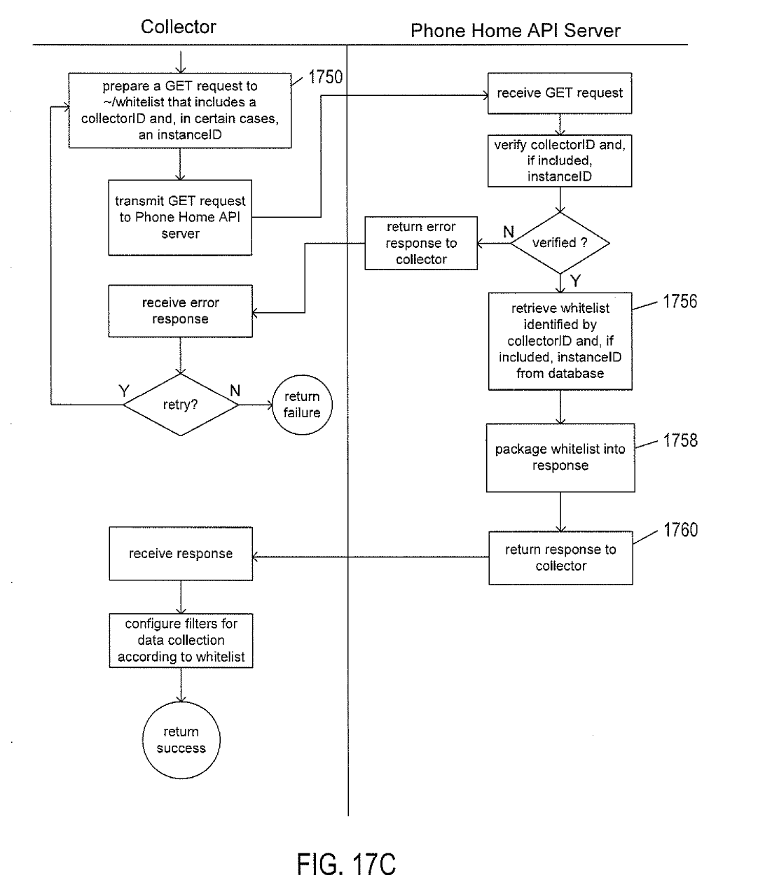

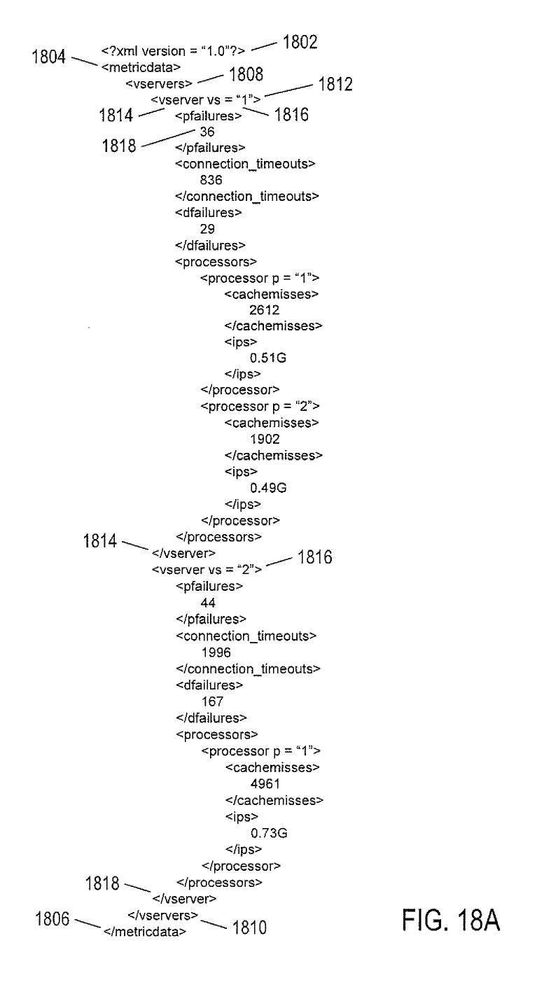

FIGS. 17A-C provide control-flow diagrams that illustrate one implementation of the phone-home API. Each of the three figures is vertically partitioned in a fashion similar to the vertical partitioning of FIG. 16. The left-hand partition includes collector-executed steps and the right-hand partition includes phone-home-system-executed steps. FIG. 17A illustrates implementation of the phone-home-API entrypoint that allows a collector to request upload of data. In step 1702, the collector prepares a POST request, directed to a URL ending in “/upload,” to request upload of data to the phone-home subsystem. The POST request includes: (1) a collectorID that specifies the type of collector; (2) an upload that serves as an identifying token for the upload; (3) an uploadSize that indicates the amount of data to be uploaded; and, in certain cases (4) an instanceID that identifies the particular collector making the request. In step 1704, the collector transmits the POST request to the phone-home API server, which receives the POST request in step 1706. In step 1708, the phone-home API server verifies the collectorID and, if included, the instanceID. When the phone-home API server is unable to verify the included IDs, as determined in step 1710, an error response is returned to the collector, in step 1712. Upon receiving the error response in step 1714, the collector determines whether or not to retry the request, in step 1716, and depending on the outcome of the determination, either returns to step 1702 to retry the request or returns a failure, in step 1718. Otherwise, when the phone-home API server is able to verify the included IDs, the phone-home API server identifies time window for the requested upload and one or more upload servers that are available to handle the upload request, in step 1720. In order to obtain this information, as well as the information needed to verify the included IDs in step 1708, the phone-home API server accesses the database (1428 in FIG. 14C). When the phone-home API server is unable to identify server resources for the upload operation, as determined in step 1722, the phone-home API server returns an error response in step 1712. Otherwise, in step 1724, the phone-home API server packages upload information into a response that is returned to the collector in step 1726. The upload information includes a start time and time-window length for the upload operation as well as a list of upload servers, the information for each upload server including a format for encoding the metric data, a protocol for the upload, a communications address for the server, a port to which to direct the upload operation, a set of one or more upload credentials that are included in the upload request for authorization purposes, a target file name for the data on the upload server, and other information needed to carry out the metric-data upload. The collector receives the response in step 1728 and, in step 1730, stores the upload information and configures an upload operation to occur within the time window specified by information included in the response.

FIG. 17B provides a control-flow diagram for the phone-home-API entrypoint that allows a collector to request a current data-collection manifest from the phone-home API server that specifies the data to be subsequently collected by the collector within a remote computing facility. In step 1732, the collector prepares a GET request, directed to a URL ending in “/manifest,” that includes a collectorID and, in certain cases, an instanceID. Many of the subsequent steps are similar to those already discussed above, with reference to FIG. 17A, and are not therefore again described. Once the GET request has been received and verified by the phone-home API server, the phone-home API server, in step 1740, retrieves a data-collection manifest identified by the collectorID and, if included in the request, the instanceID from the database and, in step 1742, packages the data-collection manifest into a response that is returned to the collector, in step 1744.

FIG. 17C provides a control-flow diagram for the phone-home-API entrypoint that allows a collector to request a data-export whitelist from the phone-home API server. In step 1750, the collector prepares a GET request, directed to a URL that ends with “/white list,” and that includes a collectorID and, in certain cases, an instanceID. When the phone-home API server has received and verified the request, the phone-home API server, in step 1756, retrieves a data-export whitelist from the database identified by the collectorID and, if included, the instanceID, packages the data-export whitelist into a response, in step 1758, and returns the response to the collector, in step 1760.

The consumption REST API (1432 in FIG. 14C) is similarly implemented as a set of entrypoints that allow the data-processing and data-analysis entities within the data-processing and data-analysis system to search for and retrieve data from the staging facility (1426 in FIG. 14C) or from an archive. Because the currently disclosed data-export whitelist and data-extraction methods do not involve the consumption API, the consumption API is not further discussed.

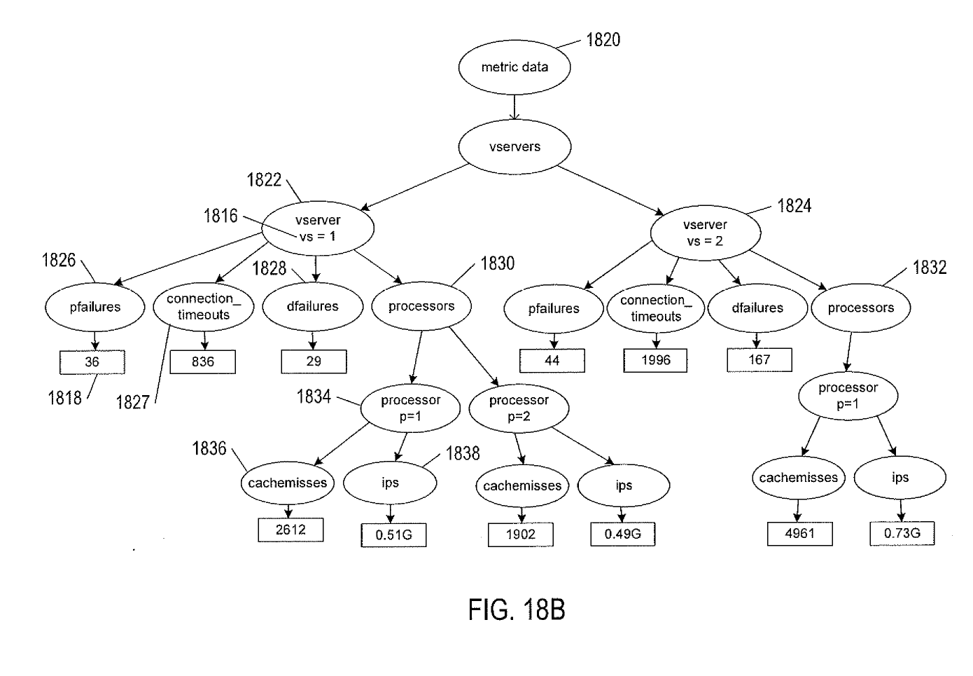

As discussed above, the collected data is generally systematically encoded using a data-encoding language such as XML or JSON. In the following discussion, XML is used as an example of a systematic, hierarchical data-encoding language. FIGS. 18A-B illustrate XML-encoded data. FIG. 18A shows a small XML document containing various types of metric data. The first line 1802 is an XML declaration that indicates the XML version used to encode data within the document. The document is hierarchically organized as nodes of various types. Element nodes begin with a start tag, such as start tag 1804, and end with a matching end tag, such as end tag 1806. The first element bounded by start tag 1804 and end tag 1806 is referred to as the root element and has the name “metric data.” The next-lower, or second-level, element “vservers” begins with start tag 1808 and ends with end tag 1810. At a third level, there are two vserver elements, including a first vserver element that begins with start tag 1812 and ends with end tag 1814 and a second vserver element that begins with start tag 1816 and ends with end tag 1818. Start tag 1812 includes the element name “vserver” 1814 as well as an attribute node vs=“1” 1816 that assigns the value 1 to the attribute vs. The first fourth-level node “pfailures” includes a text node 1818 containing the text “36.” The XML language includes a variety of different constructs, including 7 different nodes types, various keywords, and various reserved symbols. A full description of the XML language can be found in many textbooks and Internet tutorials. In the simple examples used in describing the currently disclosed systems and methods, a data value is encoded as text within a text node and a description of the data values is provided by the hierarchical node names along a path leading from the root element node to the element node containing the text node. For example, the data value “36” 1818 is the number of pfailures observed for a first virtual server of a set of virtual servers for which metric data is encoded in the example document.

The contents of the example XML document shown in FIG. 18A can be alternatively graphically represented as a tree. FIG. 18B shows a graphical tree representation of the XML document shown in FIG. 18A. Element nodes are represented by ellipses, such as ellipse 1820. Attribute nodes, such as attribute node vs=“1” 1816 are included within the ellipse 1822 representing the containing element node. Data values are contained in text nodes, represented by rectangles, such as the text node 1818. As can be more clearly seen by inspecting the graphical tree representation, the XML document shown in FIG. 18A includes a number of metric-data values for two vservers represented by element nodes 1822 and 1824. Metric data encoded for each vserver includes a number of pfailures, a number of connection timeouts, and a number of dfailures, as represented by subtrees beginning with element nodes 1826-1828 that are children of the vserver element node 1822. Each vserver is also associated with a number of processors represented by the subtrees that begin with the processors element nodes 1830 and 1832. Each processor, such as the processor represented by processor element node 1834, is characterized by a number of cache misses and an instruction-per-second value. In the case of the processor represented by element node 1834, the number of cache misses and the instruction-per-second value represented by subtrees that begin with the element nodes 1836 and 1838.

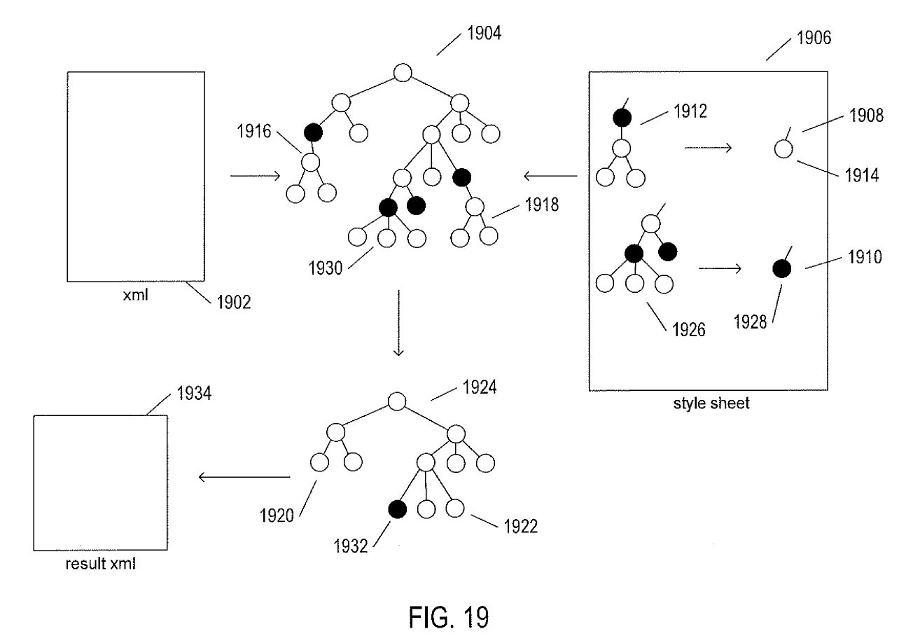

As discussed above with reference to FIG. 16, the extractor component 1626 of a collector extracts data for transmission to the phone-home subsystem from an XML data-containing document. The extractor thus employs a method for selecting exportable data from a first XML data-containing document and either placing the exportable data into a second XML document for transmission to the phone-home subsystem or streams the exportable data to the phone-home subsystem. One approach that can be used to extract data from an XML data-containing document involves use of XML stylesheets. FIG. 19 illustrates the use of an XML stylesheet to extract a portion of the data contained in a first XML document for inclusion into a second, or result, XML document. In FIG. 19, the first XML document 1902 is parsed by an XML processor to create a tree-like representation of the data contained in the XML document 1904. A separate XML stylesheet 1906 includes declarative directives, such as directives 1908 and 1910, that specify transformations to be carried out on particular types of nodes and subtrees of the tree-like representation 1904. For example, the first directive indicates that a subtree of the form 1912 is replaced by a single node of the form 1914. Thus, subtrees 1916 and 1918 in the tree-like representation 1904 of the contents of the first XML document 1902 are replaced by single nodes 1920 and 1922 in a result tree 1924. Similarly, the second directive 1910 specifies that a subtree of the form 1926 is replaced by a single node of the form 1928. Therefore, subtree 1930 in the tree-like representation 1904 is replaced, in the result tree-like representation 1924, by the single node 1932. Once all the directives have been applied, the result tree-like representation 1924 is reencoded in the XML language as a result XML document 1934.

While XML-stylesheet technology is readily available and well-understood, the XML-stylesheet approach is relatively inefficient. The initial XML document 1902 is first converted, in its entirety, into the tree-like representation 1904 stored in memory prior to being transformed using the stylesheet. The metric-data-containing XML data files returned by collectors to the phone-home subsystem may be quite large, containing hundreds, thousands, tens of thousands, or more pages of XML, and the use of a stylesheet to transform a data-containing XML document into an exportable-data-containing XML document would represent a significant, and often prohibitive, memory-consumption overhead. State-of-the-art XSLT processing uses an amount of memory proportional to the size of the document, with the proportionality factor at least 2.0 for documents that contain metrics and similar data. By contrast, the currently disclosed methods for extracting exportable data from an XML data-containing document use an amount of memory proportional to the depth of the tree-like representation of the document. As one example, XSLT processing would use at least 400 MB of memory to process a 200 MB document, while the currently disclosed methods would around 100 KB of memory for processing the same document, a 4000-fold memory-usage reduction compared to that of XSLT processing. In virtual-memory-based computing systems, the use of a stylesheet to transform a data-containing XML document into an exportable-data-containing XML document would also be associated with a computational-bandwidth overhead and a mass-storage-access overhead, which are also significantly lower for the currently disclosed methods.

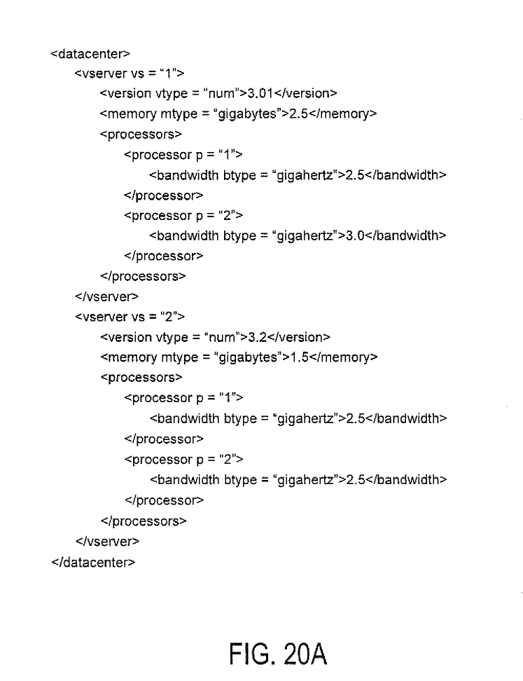

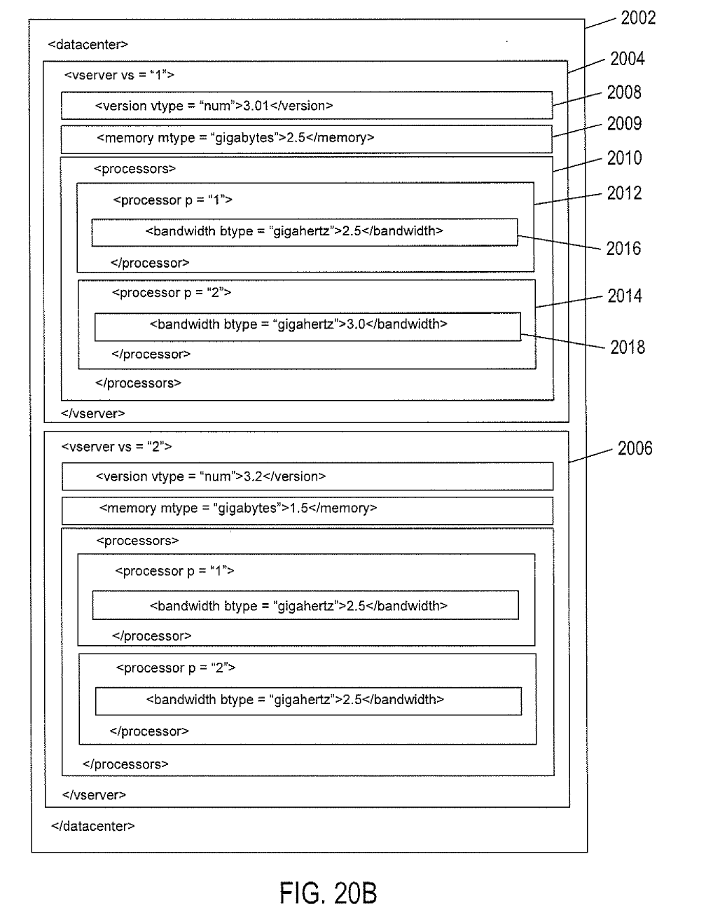

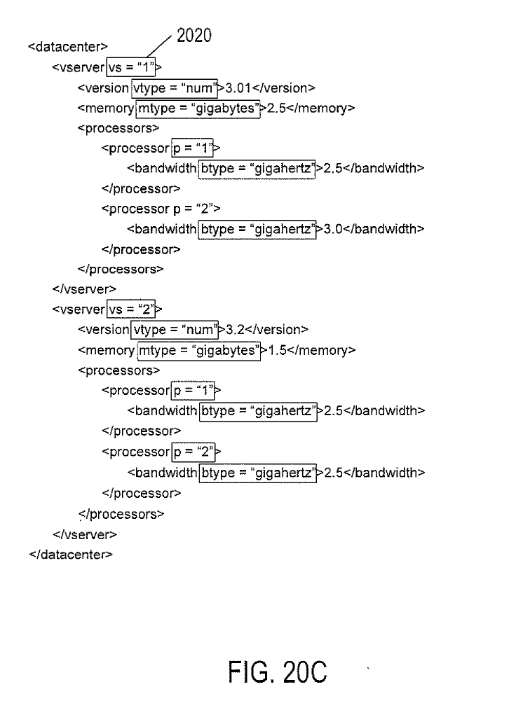

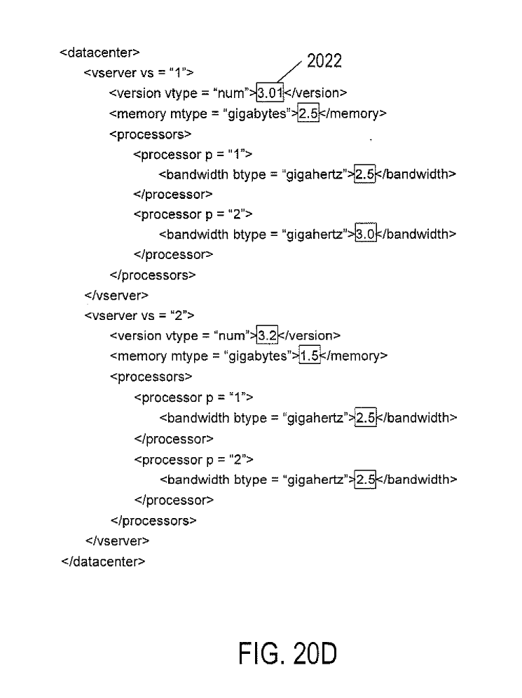

FIGS. 20A-D provide a simpler example of a data-containing XML document. FIG. 28 shows the XML that encodes data describing the configuration of 2 virtual servers. FIG. 20B illustrates the element nodes within the XML document shown in FIG. 20A. The root node is contained within the outer rectangle 2002. Two second-level nodes representing virtual servers are contained within rectangles 2004 and 2006. Each vserver node contains three third-level nodes, such as the third-level nodes 2008-2010 within the server node 2004. The processors node 2010 includes two fourth-level processor nodes 2012 and 2014. Each processor node contains a bandwidth node 2016 and 2018. FIG. 20C shows the attribute nodes contained in the XML document shown in FIG. 20A. Each attribute note is enclosed within a rectangle, such as rectangle 2020. FIG. 20D shows the text nodes within the XML document shown in FIG. 28. Each text note is shown enclosed within a rectangle, such as rectangle 2022.

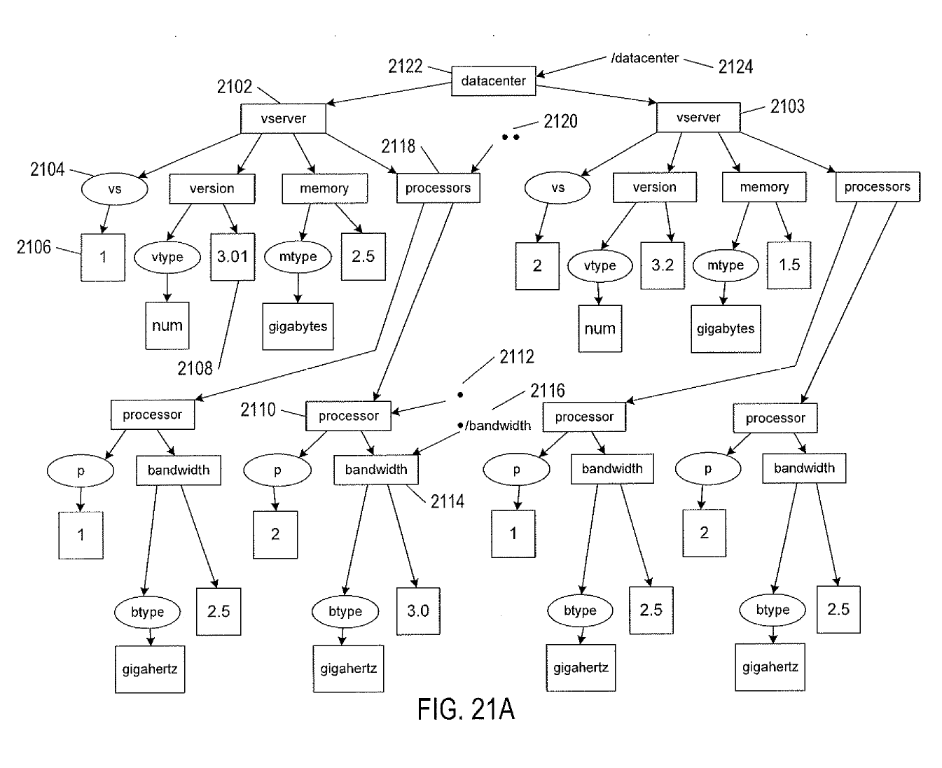

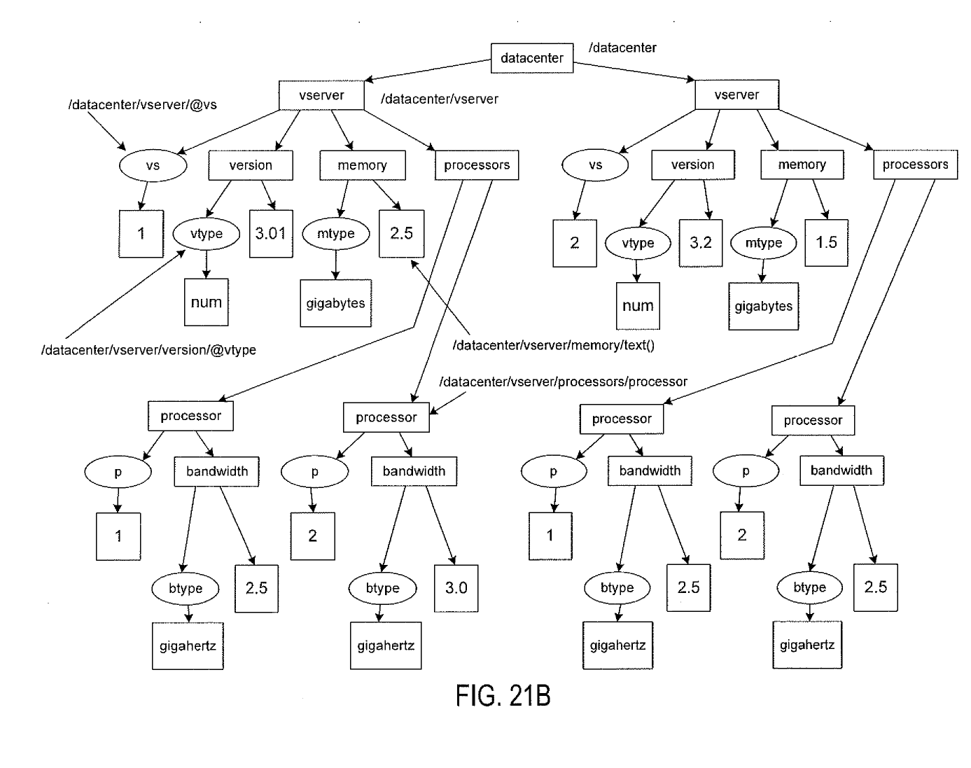

FIGS. 21A-B show graphical tree-like representations of the XML document shown in FIG. 20A. Element nodes are shown as labeled rectangles, such as rectangle 2102. Attribute nodes are shown as subtrees rooted by an ellipse, such as ellipse 2104, with a single child attribute-value node, such as the attribute-value node 2106. Text nodes, such as text node 2108, are shown as child nodes of their parent element nodes. Each node within the tree-like representation of the XML document can be described by a pathname, analogous to pathnames used to describe files within the hierarchical file directories of a computer operating system or analogous to URLs and URIs used to describe resources within a hierarchically organized set of computational resources accessible through the Internet. The tree-like representation of the XML document can be computationally traversed, with a particular node considered to be the current node at any given point in time. In FIG. 21A, processor node 2110 is the current node, and the pathname for the current node is a single “.” symbol 2112. The bandwidth child element node of the current node 2114 can be represented by the pathname “./bandwidth” 2116. The parent of the current node 2118 is represented by the pathname “..” 2120. Pathnames that begin with a “.” are referred to as relative pathnames. By contrast, a full pathname begins with “/” and the name of the element root node and, for lower level nodes, includes additional “/” symbols and lower-level element-node names. The full pathname for root node 2122 is “/datacenter” 2124. FIG. 21B shows full pathnames for various nodes within the tree-like representation of the XML document shown in FIG. 20A. Note that the symbol “@” is used to indicate that an attribute name follows and the functional notation text( ) is used to indicate a text node.

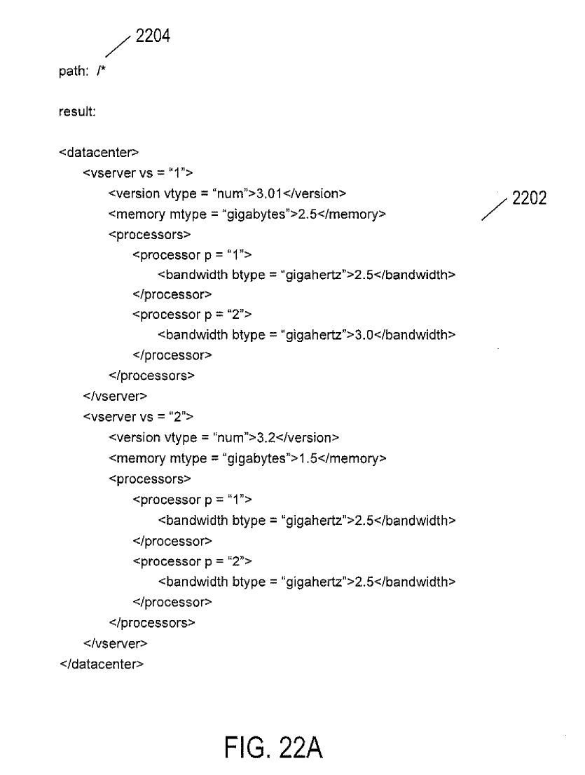

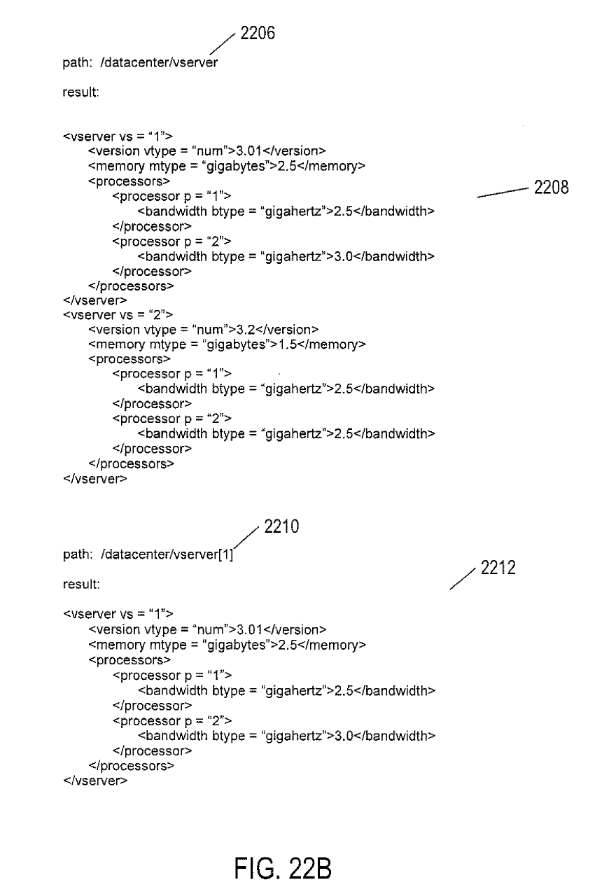

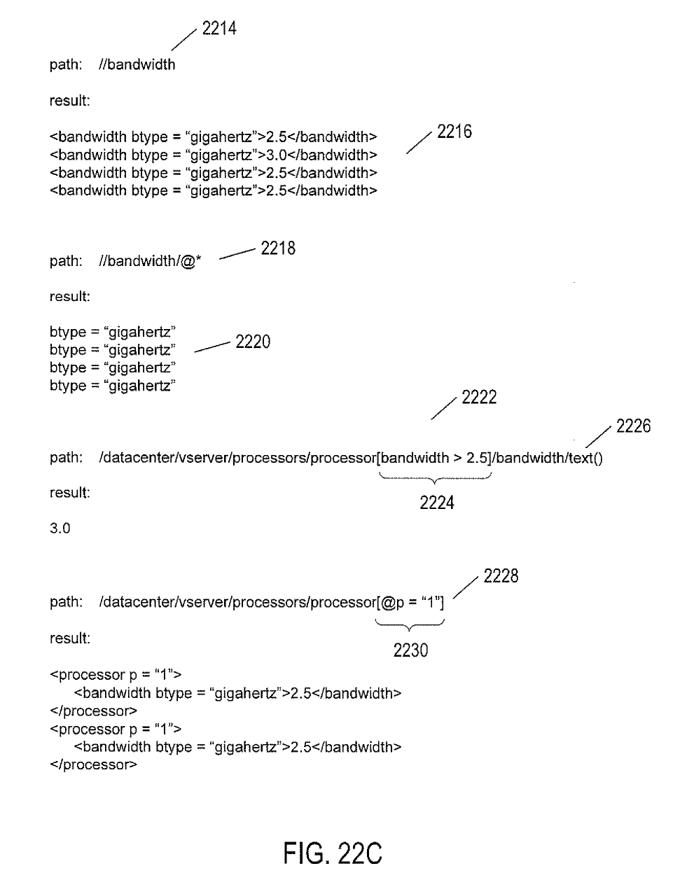

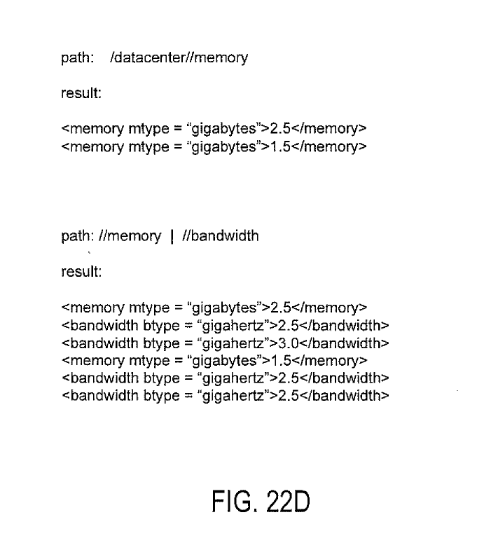

Pathname-like regular expressions can be used to select nodes and other components from an XML document. For example, Xpath expressions are regular expressions with pathname-like syntax that have been developed for selecting components of XML documents for various purposes. FIGS. 22A-D provide examples of pathname-like regular expressions operating on the XML document provided in FIG. 20A. FIG. 22A illustrates the result 2202 obtained by applying the regular expression “/*” 2204 to the XML document shown in FIG. 20A. The symbol “*” is a wild-card symbol and the regular expression “/*” indicates selection of everything within, and at lower levels with respect to, the root node. Thus, the result 2202 shown in FIG. 22A is the same as the original XML document shown in FIG. 20A. FIG. 22B shows 2 more examples of pathname-like regular expressions applied to the XML document shown in FIG. 20A. The pathname-like regular expression “/data center/vserver” 2206 selects both vserver nodes (2102 and 2103 in FIG. 20 1A) 2208, since both vserver nodes are represented by the pathname “/data center/vserver.” However, the regular expression “/data center/vserver [1]” 2210 selects only the first vserver node 2212. FIG. 22C shows four additional examples of applying pathname-like regular expressions to the XML document shown in FIG. 20A. The pathname-like regular expression “//bandwidth” 2214 selects any element node with the name “bandwidth” 2216, regardless of where the element appears in the tree-like representation of the XML document. The pathname-like regular expression “//bandwidth! c@” 2218 selects any attributes of any element nodes with the name “bandwidth,” regardless of where they appear in the tree-like representation of the XML document 2220. In the pathname-like regular expression 2222, the relational expression within brackets 2224 selects processor element nodes with child bandwidth nodes having text expressions representing values greater than 2.5 and the text( ) functional notation 2226 selects the contents of a text node. The pathname-like regular expression 2228 includes an expression 2230 that selects processor element nodes with p attributes equal to 1. Additional examples are shown in FIG. 22D. Of course, a complete specification of Xpath regular expressions, and specifications of other types of regular expressions that can be used to select components from hierarchically organized documents, are available in textbooks and on-line. In essence, pathname-like regular expressions are sufficiently flexible to provide a means for selection of any particular component or set of components from an XML document.

In the currently disclosed method for extracting exportable data from an XML data-containing document, a data-export whitelist comprising one or more pathname-like regular expressions is used to control extraction of the exportable data. A data-export whitelist comprising pathname-like regular expressions is a concise and flexible specification for selecting exportable data and, as discussed below, can be processed more efficiently than traditional XML stylesheets. Significantly, the disclosed method for extracting exportable data from an XML data-containing document does not require an in-memory transformation of the XML document into a tree-like representation of the XML document, thus eliminating certain of the memory-consumption overheads associated with application of XML stylesheets to XML documents.

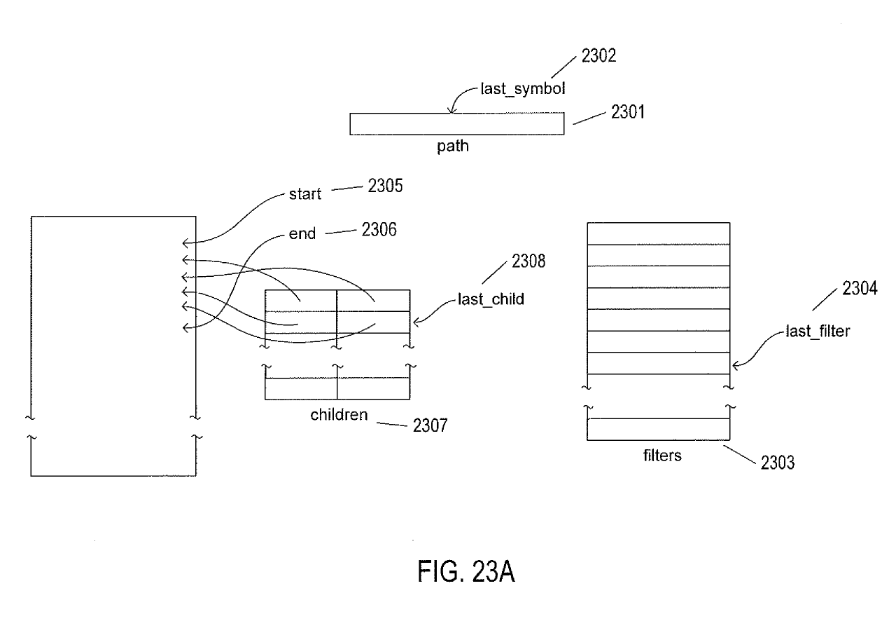

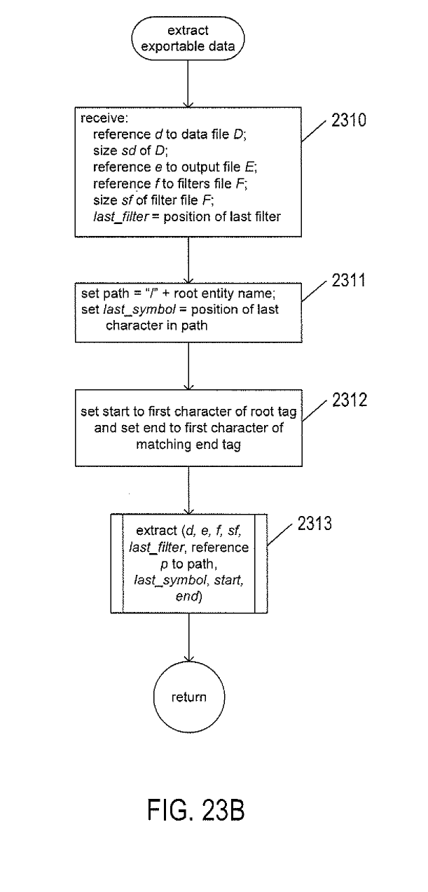

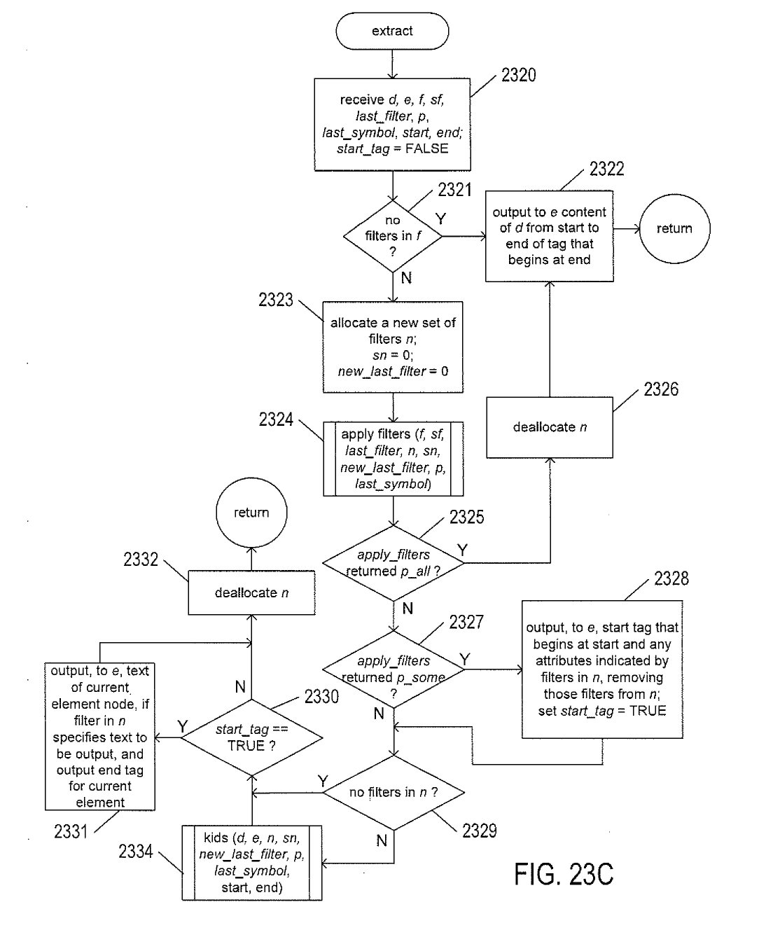

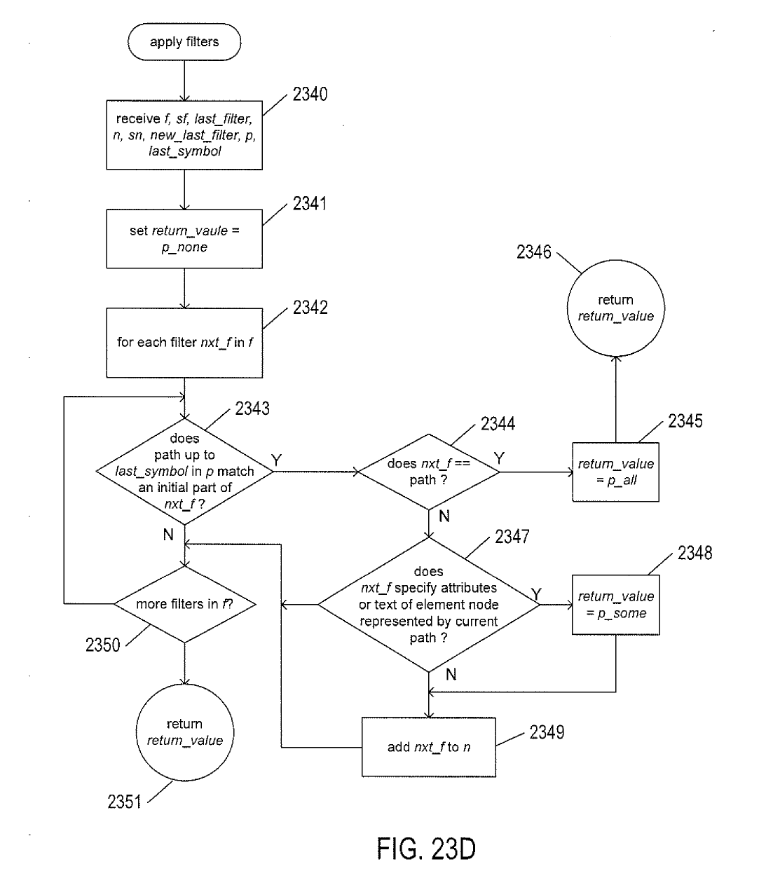

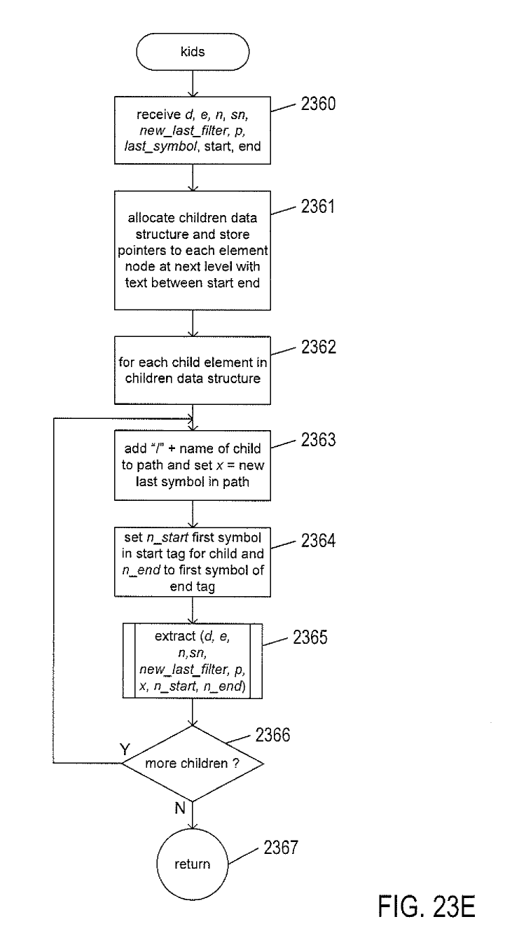

FIGS. 23A-E provide data-structure diagrams and the control-flow diagrams that illustrate application of pathname-like regular expressions contained in a data-export whitelist to a data-containing XML document to select exportable data from the data-containing XML document for transmission to a phone-home subsystem from a collector resident within a computing facility. FIG. 23A shows data structures used in the control-flow diagrams of FIGS. 23B-E. A variable-length string, path 2301, contains a pathname representation of a currently considered element node within an XML document. An index last_symbol 2302 indicates the last symbol that should be considered as part of the pathname. A set of filters 2303 represents the relevant pathname-like regular expressions of the data-export whitelist for application to the currently considered node and lower-level nodes contained within the currently considered node. In other words, the term “filter” refers to a pathname-like regular expression. An index or pointer last_filter 2304 indicates the position of the last or final filter to be considered. The pointers start 2305 and end 2306 indicate positions of a currently considered node within the XML document. A data structure children 2307 includes pairs of pointers or indexes that each represents a child node contained within the currently considered node. A pointer or index last_child 2308 indicates position of the last child within a data structure.

FIG. 23B provides a highest-level control-flow diagram for a routine “extract exportable data” that extracts exportable data from a data-containing XML document and copies the extracted data into a results file. In step 2310, the routine “extract exportable data” receives: (1) a reference d to a data-containing XML document or file D; (2) an indication, sd, of the size of D; (3) a reference e to an output file or document E; (4) a reference f to a filters file F, containing pathname-like regular expressions originally obtained from a data-export whitelist; (5) an indication of the size, sf, of the filter file F; and (6) a pointer or index last_filter. In step 2311, the routine “extract exportable data” places a full pathname for the root element in the input XML document into the variable-like string path and sets the pointer or index last_symbol to indicate the position of the last character in the pathname. In step 2312, the routine “extract exportable data” sets the pointer start to the first character of the root-node tag and sets the pointer end to the first character of the matching root-node end tag. Finally, in step 2313, the routine “extract exportable data” calls a recursive routine “extract” to extract the data specified by the data-export whitelist from the input XML data-containing file D and place the extracted data in the output file E. Of course, the routine “extract exportable data” can also be implemented as a purely iterative routine. However, for simplicity of explanation and illustration, a recursive implementation is shown in FIGS. 23B-E.

FIG. 23C provides a control-flow diagram for the routine “extract,” called in step 2313 of FIG. 23B. In step 2320, the routine “extract” receives arguments passed to the routine in step 2313 of FIG. 23B and sets a Boolean local variable start_tag to FALSE. It is assumed that those arguments with values changed in the receiving routine are passed by reference and those arguments with values that are not changed in the receiving routine are passed by value. When there are no filters in the set of filters F, as determined in step 2321, the entire contents of the data-containing XML document D are output to the output file E, in step 2322. Otherwise, in step 2323, the routine “extract” allocates a data structure to contain a new set of filters, sets the size of this data structure to 0, and sets the pointer new_last_filter to 0. In step 2324, the routine “extract” calls a routine “apply filters” to apply filters in the set of filters F to the current node represented by the value in the variable-like string path. When the routine “apply filters” returns a value p_all, as determined in step 2325, a filter was found that indicates that the entire contents of the currently considered node should be output to output file E. Therefore, the new set of filters n is deallocated, in step 2326, and the currently considered node is output to the output file, in step 2322. When, by contrast, the routine “apply filters” returns a value p_some, as determined in step 2327, any attributes of the currently considered node specified by one or more filters in F are output to the output file in step 2328, along with the start tag for the currently considered node. In addition, any of the filters that specify attributes and values of the currently considered node are removed from the set of filters n. When there are no filters remaining in the set of filters n, as determined in step 2329, control flows to step 2330, where the routine “extract” determines whether the Boolean value start_tag has been set to TRUE. If so, then, in step 2331, the routine “extract” outputs text contained in the currently considered element node, if any, when a filter in n specifies that the text should be output, and additionally outputs the end tag for the currently considered element node. In step 2332, the set of filters n is deallocated. When, as determined in step 2329, there are filters remaining in the set of filters n, the routine “kids” is called, in step 2334, to find any children nodes of the currently considered node and to recursively call the routine “extract” for each child node.

FIG. 23D provides a control-flow diagram for the routine “apply filters,” called in step 2324 of FIG. 23C. In step 2340, the routine “apply filters” receives arguments passed to the routine “apply filters” in step 2324 of FIG. 23C. In step 2341, the routine “apply filters” sets a return value equal to p_none. In the for-loop of steps 2342-2350, each filter nxt_f in the set of filters F is considered. When the pathname of the currently considered node stored in the variable-length string path matches all or an initial part of the currently considered filter nxt_f; asked determined in step 2343, and when the currently considered filter nxt_f is equal to the pathname, as determined in step 2344, the return value is set to p_all, in step 2345, and the return value is returned in step 2346. When the currently considered filter nxt_f is not equal to the pathname for the currently considered node, as determined in step 2344, but when the currently considered filter nxt_f specifies attributes and/or text within the currently considered element node, as determined in step 2347, the return value is set to p_some, in step 2348. The currently considered filter nxt_f is added to the set of filters in step 2349. Control then flows to step 2350, as is also in the case when the pathname of the currently considered node does not match all or an initial part of the currently considered filter nxt_f. When there are more filters in the set of filters F, as determined in step 2350, a next iteration of the for-loop of steps 2342-2350 is undertaken. Otherwise, the return value is returned in step 2351.

FIG. 23D provides a control-flow diagram for the routine “kids,” called in step 2334 of FIG. 23C. In step 2360, the routine “kids” receives the arguments passed to the routine in step 2334 of FIG. 23C. In Step 2361, the routine “kids” allocates a children data structure and stores pointers to each element node at the next level within the currently considered node, obtained by parsing the XML bounded by the pointers start and end. In the for-loop of steps 2362-2366, each child node, pointers to which are stored in the children data structure, is considered. In step 2363, the pathname to the child node is stored in the variable-length string path. In step 2364, an n_start pointer or index is set to the first symbol in the start tag for the child and an n_end pointer or index is set to the first symbol of the end tag of the child. Then, in step 2365, the routine “extract” is called recursively to process the child node. When there are more children in the data structure children, as determined in step 2366, control returns to step 2363 for a next iteration of the for-loop of steps 2362-2366. Otherwise, the routine “kids” returns in step 2367.

Thus, as illustrated by the routine “extract exportable data,” the currently disclosed method for extracting exportable data from a document or file containing hierarchically encoded data involves a single pass through the text in the data-containing document and matching nodes to regular expressions contained in a whitelist. The whitelist controlled process is efficient and flexible and provides for efficient data collection by the distributed subsystem comprising collectors and the phone-home subsystem.

Although the present invention has been described in terms of particular embodiments, it is not intended that the invention be limited to these embodiments. Modifications within the spirit of the invention will be apparent to those skilled in the art. For example, any of many different implementation and design parameters, including choice of operating system, virtualization layer, hardware platform, programming language, modular organization, control structures, data structures, and other such design and implementation parameters can be varied to generate a variety of alternative implementations of the current disclosed methods and systems. As mentioned above, any of many different data-encoding languages and techniques can be used to encode metric data in documents or files. Many different file-transfer and communications technologies can be used for transmitting data from collectors to the phone-home subsystem. The data-processing and data-analysis components that access collected data through the consumption API may be located in the same computing facility as the phone-home subsystem or in a different computing facility.

1. A data-collection subsystem distributed across multiple computing facilities, each having multiple computer systems, the data-collection subsystem comprising:
one or more collectors, each resident within a different computing facility selected from a set of monitored computing facilities, that each collects data from the computing facility within which the collector operates according to a manifest and that each exports collected data according to a whitelist; and
a phone-home subsystem within a monitoring computing facility that provides manifests and whitelists to the collectors upon request and that receives data exported by the collectors for storage and subsequent use by data-processing and data-analysis components of the monitoring computing facility or of remote computing facilities.

2. The data-collection subsystem of claim 1 wherein a collector collects data according to a manifest by:
processing the manifest to determine a set of data that can be collected from the computing facility within which the collector operates;
collecting data of the determined set of data; and
packaging the collected data into a hierarchical data encoding within a data document.

3. The data-collection subsystem of claim 2 wherein the manifest contains a hierarchically encoded specification of the data to be collected by the collector.

4. The data-collection subsystem of claim 2 wherein the collector packages the collected data into a hierarchical data encoding within data documents at intervals determined by one or more of:
the amount of collected but unpackaged data; and
the time elapsed since a previous data packaging.

5. The data-collection subsystem of claim 1 wherein a collector requests a manifest through a phone-home API provided by the phone-home subsystem by transmitting a manifest request that includes one or more of:
a collector ID; and
an instance ID.

6. The data-collection subsystem of claim 1 wherein a collector exports data according to a whitelist by:
processing hierarchically encoded data in a data document using the whitelist to select particular data-encoding nodes within the data document; and
incorporating the selected data-encoding nodes into a document or file that is transferred to the phone-home subsystem or streaming the selected data-encoding nodes to the phone-home subsystem.

7. The data-collection subsystem of claim 6 wherein a collector requests a whitelist through a phone-home API provided by the phone-home subsystem by transmitting a whitelist request that includes one or more of:
a collector ID; and
an instance ID.

8. The data-collection subsystem of claim 6 wherein the whitelist contains a set of one or more filters, each filter comprising a pathname-like regular expressions.

9. The data-collection subsystem of claim 8 wherein processing hierarchically encoded data in a data document using the whitelist to select particular data-encoding nodes within the data document further comprises:
beginning with a root node as the currently considered node in the data document traversing the hierarchically encoded data by,
determining a pathname for the currently considered node;
attempting to match filters extracted from the whitelist to the determined pathname;
when a matching filter indicates that the entire currently considered node should be exported, selecting the entire currently considered node for export;
when no matching filter indicates that the entire currently considered node should be exported,
when one or more matching filters indicate that attributes of the currently considered should be exported, selecting the attributes for export, and
selecting, as next currently considered nodes for subsequent filter matching and traversal, any children of the currently considered node.

10. The data-collection subsystem of claim 1 wherein a collector, prior to exporting data to the phone-home subsystem, schedules transmission of data to the phone-home subsystem, as a document or file or by streaming, by requesting scheduling of a data transfer through a phone-home API provided by the phone-home subsystem by transmitting a data-transfer-scheduling request that includes:
a collector ID;
an indication of a transfer size; and
an upload ID.

11. The data-collection subsystem of claim 10 wherein the data-transfer-scheduling request further includes:
an instance ID.

12. The data-collection subsystem of claim 1
wherein the phone-home subsystem provides manifests and whitelists to the collectors upon request and receives data-transfer-scheduling requests from collectors through a phone-home API; and
wherein the phone-home subsystem receives data transmitted by the collectors to the phone-home subsystem through one or more upload servers.

13. The data-collection subsystem of claim 1 wherein the phone-home subsystem returns a data-transfer schedule in response to receiving a data-transfer-scheduling request, the data-transfer-scheduling request including:
an indication of a start time for the data transfer;
an indication of a length of time for which the schedule is valid following the start time; and
data-transfer parameters.

14. The data-collection subsystem of claim 13 wherein the data-transfer parameters include:
for each of one or more upload servers,
an indication of a data-encoding format;
an indication of a transfer protocol;
an indication of a communications address for the upload server;
an indication of a port; and
upload credentials.

15. The data-collection subsystem of claim 1 wherein the phone-home subsystem includes:
a phone-home API server that exposes a phone-home API;
one or more upload servers that receive data exported by the one or more collectors;
a database that stores information about collectors and that indexes data received from the one or more collectors;
a data-staging component that stores data received from the one or more collectors;
a downloader that removes data received from the one or more collectors from the one or more upload servers and stores the data in the data-staging component; and
a web portal that exposes a consumption API through which data stored in the data-staging component is accessed by data-processing and data-analysis entities.

16. A method that extracts exportable data from a document containing hierarchically encoded data, the method comprising:
accessing a white list containing one or more filters, each filter comprising a pathname-like regular expression; and
applying the filters to the document containing hierarchically encoded data to select the exportable data.

17. The method of claim 16 wherein applying the filters to the document containing hierarchically encoded data to select the exportable data further comprises:
selecting a root node in the document containing hierarchically encoded data as a first currently considered node and selecting the filters in the white list as a first current set of relevant filters; and
traversing the hierarchically encoded data, in each step of the traversal
applying a current set of relevant filters to a currently considered node to obtain export-data-selection criteria for the currently considered node,
selecting exportable data based on the export-data-selection criteria, and
when the entire currently considered node is not selected for export and when the currently considered node contains one or more children nodes,
selecting each child node as a subsequent currently considered node and selecting one or more filters in the current set of relevant filters as a subsequent next current set of filters for one or more subsequent steps in traversing the hierarchically encoded data.

18. The method of claim 17 wherein the export criteria indicate one of:
selecting the entire currently considered node for export;
selecting one or more attributes and text nodes contained within the currently considered node for export; and
selecting nothing from the currently considered node.

19. The method of claim 17 wherein selecting one or more filters in the current set of relevant filters as a subsequent next current set of filters further comprises:
selecting those filters in the current set of relevant filters that may match descendant nodes of the currently considered node.

20. A physical data-storage device that stores a sequence of computer instructions that, when executed by one or more processors within one or more computer systems within a computing facility, control the computing facility to:
request a manifest from a phone-home subsystem;
request a whitelist from the phone-home subsystem, the whitelist comprising a set of one or more filters, each filter comprising a pathname-like regular expression;
collect data from the computing facility according to the manifest and package the data in a hierarchically encoded document or file;
extract exportable data from the hierarchically encoded document or file according to the whitelist; and
transfer the exportable data to the phone-home subsystem.
